(19) United States
(12) Patent Application Publication
(10) Pub. No.: US 2025/0338187 A1
(43) Pub. Date: Oct. 30, 2025

(54) METHOD AND APPARATUS FOR ENHANCED L1 MEASUREMENT REPORT

(71) Applicant: Samsung Electronics Co., Ltd., Suwon-si, Gyeonggi-do (KR)

(72) Inventors: Deokhui LEE, Suwon-si (KR); Dongmyung KIM, Suwon-si (KR); Sangho LEE, Suwon-si (KR); Hoyoung YOON, Suwon-si (KR)

(21) Appl. No.: 19/193,425

(22) Filed: Apr. 29, 2025

(30) Foreign Application Priority Data
Apr. 29, 2024 (KR) 10-2024-0056999
Jul. 1, 2024 (KR) 10-2024-0085915

(51) Int. Cl. H04W 36/04; H04W 36/00; H04W 56/00; H04W 72/21

(52) U.S. Cl. CPC H04W 36/04; H04W 36/0058; H04W 56/0015; H04W 72/21

(57) ABSTRACT

The present disclosure relates to a 5G communication system or a 6G communication system for supporting higher data rates beyond a 4G communication system such as long term evolution (LTE). A method performed by a terminal in a communication system is provided. The method includes receiving a configuration associated with a layer 1/layer 2 triggered mobility (LTM) through higher layer signaling, obtaining uplink control information (UCI) for a layer 1 measurement report (L1 MR) related to the LTM, and transmitting the UCI, wherein the UCI includes information fields for N samples, and wherein an information field for each sample includes 6-bit information indicating a synchronization signal block (SSB) index and 1-bit information corresponding to the SSB index and indicating whether an event condition configured for the L1 MR is satisfied.

### CROSS-REFERENCE TO RELATED APPLICATION(S)

This application is based on and claims priority under 35 U.S.C. § 119 (a) of a Korean patent application number 10-2024-0056999, filed on Apr. 29, 2024, in the Korean Intellectual Property Office, and of a Korean patent application number 10-2024-0085915, filed on Jul. 1, 2024, in the Korean Intellectual Property Office, the disclosure of each of which is incorporated by reference herein its entirety.

### BACKGROUND

### 1. Field

The disclosure relates to a wireless communication system. More particularly, the disclosure relates to a method and apparatus for an enhanced layer 1 (L1) measurement report.

### 2. Description of Related Art

Looking back at the development of wireless communication from generation to generation, technologies have been developed mainly for human-targeted services such as a voice call, a multimedia service, and a data service. After the commercialization of the 5th-generation (5G) communication system, it is expected that connected devices, which are increasing explosively, will be connected to the communication network. As examples of things connected to the network, there may be vehicles, robots, drones, home appliances, displays, smart sensors installed in various infrastructures, construction machines, and factory equipment. Mobile devices are expected to evolve into various form-factors such as augmented reality glasses, virtual reality headsets, and holographic devices. In the 6th-generation (6G) era, there have been ongoing efforts to develop an improved 6G communication system in order to connect hundreds of billions of devices and things and provide a variety of services. For these reasons, the 6G communication system is called the Beyond 5G system.

The 6G communication system, which is expected to be commercialized around 2030, will have a peak data rate of tera (i.e., 1,000 giga)-level bps and a radio latency less than 100 microseconds (usec). That is, in the 6G communication system, the data rate will be 50 times faster than that of the 5G communication systems, and the radio latency will be reduced to one-tenth.

In order to accomplish such a high data rate and an ultra-low latency, it has been considered to implement 6G communication systems in a terahertz band (e.g., 95 GHz to 3 THz bands). It is expected that, due to severer path loss and atmospheric absorption in the terahertz bands than those in the millimeter wave (mm Wave) bands introduced in 5G, technologies capable of securing the signal transmission distance (i.e., coverage) will become more crucial. It is necessary to develop, as major technologies for securing the coverage, radio frequency (RF) elements, antennas, new waveforms having a better coverage than orthogonal frequency division multiplexing (OFDM), beamforming, and multi-antenna transmission technologies such as massive multiple-input multiple-output (MIMO), full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for an enhanced L1 measurement report.

Another aspect of the disclosure is to provide improvements to a mobility procedure.

Additional aspects will be set forth in part in the description which follows and, in part, will be apparent from the description, or may be learned by practice of the presented embodiments.

In accordance with an aspect of the disclosure, a method performed by a terminal in a communication system is provided. The method includes receiving a configuration associated with a layer 1/layer 2 triggered mobility (LTM) through higher layer signaling, obtaining uplink control information (UCI) for a layer 1 measurement report (L1 MR) related to the LTM, and transmitting the UCI, wherein the UCI includes information fields for N samples, and wherein an information field for each sample includes 6-bit information indicating a synchronization signal block (SSB) index and 1-bit information corresponding to the SSB index and indicating whether an event condition configured for the L1 MR is satisfied.

According to an embodiment of the disclosure, the UCI includes information fields for N samples, and an information field for one sample includes 6-bit information indicating a synchronization signal block (SSB) index and 1-bit information corresponding to the SSB index and indicating whether an event condition configured for the L1 MR is satisfied.

According to an embodiment of the disclosure, N is defined by Floor {(periodicity configured for the L1 MR)/(SSB measurement timing configuration (SMTC) periodicity)}. When the event condition is for a serving cell, a number of bits of the UCI is 7N, and when the event condition is for a neighbor cell, the number of bits of the UCI is e 7NM where M is a number of neighbor cells.

According to an embodiment of the disclosure, the neighbor cell is a candidate target cell for the LTM.

According to an embodiment of the disclosure, whether the event condition is for the serving cell or the neighbor cell is identified based on a condition identifier included in a condition configuration included in the configuration associated with the LTM.

According to an embodiment of the disclosure, the configuration associated with the LTM includes LTM-CSI-ReportConfig.

According to an embodiment of the disclosure, the LTM-CSI-ReportConfig includes a configuration indicating that the 6-bit information and the 1-bit information are included in the UCI.

According to an embodiment of the disclosure, the method further includes transmitting a medium access control (MAC) control element (CE) indicating transmission of a scheduling request (SR) for the UCI in slot n, transmitting the SR based on a first uplink grant received after slot n+k, receiving an uplink grant in response to the SR, and transmitting the UCI based on the uplink grant.

According to an embodiment of the disclosure, the MAC CE includes information related to k and information related to an identifier of the UCI.

In accordance with another aspect of the disclosure, a terminal in a communication system is provided. The terminal includes a transceiver and a processor coupled to the transceiver and configured to receive a configuration associated with a layer 1/layer 2 triggered mobility (LTM) through higher layer signaling, obtain uplink control information (UCI) for a layer 1 measurement report (L1 MR) related to the LTM, and transmit the UCI, wherein the UCI includes information fields for N samples, and wherein an information field for each sample includes 6-bit information indicating a synchronization signal block (SSB) index and 1-bit information corresponding to the SSB index and indicating whether an event condition configured for the L1 MR is satisfied.

According to an embodiment of the disclosure, the UCI includes information fields for N samples, and an information field for one sample includes 6-bit information indicating a synchronization signal block (SSB) index and 1-bit information corresponding to the SSB index and indicating whether an event condition configured for the L1 MR is satisfied.

According to an embodiment of the disclosure, N is defined by Floor {(periodicity configured for the L1 MR)/(SSB measurement timing configuration (SMTC) periodicity)}. When the event condition is for a serving cell, a number of bits of the UCI is 7N, and when the event condition is for a neighbor cell, the number of bits of the UCI is 7NM where M is a number of neighbor cells.

According to an embodiment of the disclosure, the neighbor cell is a candidate target cell for the LTM.

According to an embodiment of the disclosure, whether the event condition is for the serving cell or the neighbor cell is identified based on a condition identifier included in a condition configuration included in the configuration associated with the LTM.

According to an embodiment of the disclosure, the configuration associated with the LTM includes LTM-CSI-ReportConfig, and the LTM-CSI-ReportConfig includes a configuration indicating that the 6-bit information and the 1-bit information are included in the UCI.

According to an embodiment of the disclosure, the processor is further configured to transmit a medium access control (MAC) control element (CE) indicating transmission of a scheduling request (SR) for the UCI in slot n, transmit the SR based on a first uplink grant received after slot n+k, receive an uplink grant in response to the SR, and transmit the UCI based on the uplink grant.

According to an embodiment of the disclosure, the MAC CE includes information related to k and information related to an identifier of the UCI.

In accordance with another aspect of the disclosure, a method performed by a base station in a communication system is provided. The method includes transmitting a configuration associated with a layer 1/layer 2 triggered mobility (LTM) through higher layer signaling, and receiving uplink control information (UCI) for a layer 1 measurement report (L1 MR) related to the LTM, wherein the UCI includes information fields for N samples, and wherein an information field for each sample includes 6-bit information indicating a synchronization signal block (SSB) index and 1-bit information corresponding to the SSB index and indicating whether an event condition configured for the L1 MR is satisfied.

According to an embodiment of the disclosure, the UCI includes information fields for N samples, and an information field for one sample includes 6-bit information indicating a synchronization signal block (SSB) index and 1-bit information corresponding to the SSB index and indicating whether an event condition configured for the L1 MR is satisfied.

According to an embodiment of the disclosure, N is defined by Floor {(periodicity configured for the L1 MR)/(SSB measurement timing configuration (SMTC) periodicity)}. When the event condition is for a serving cell, a number of bits of the UCI is 7N, and when the event condition is for a neighbor cell, the number of bits of the UCI is NM where M is a number of neighbor cells.

According to an embodiment of the disclosure, the neighbor cell is a candidate target cell for the LTM.

According to an embodiment of the disclosure, whether the event condition is for the serving cell or the neighbor cell is identified based on a condition identifier included in a condition configuration included in the configuration associated with the LTM.

According to an embodiment of the disclosure, the configuration associated with the LTM includes LTM-CSI-ReportConfig.

According to an embodiment of the disclosure, the LTM-CSI-ReportConfig includes a configuration indicating that the 6-bit information and the 1-bit information are included in the UCI.

According to an embodiment of the disclosure, the method further includes receiving a medium access control (MAC) control element (CE) indicating transmission of a scheduling request (SR) for the UCI in slot n, receiving the SR related to a first uplink grant transmitted after slot n+k, transmitting an uplink grant in response to the SR, and receiving the UCI related to the uplink grant.

According to an embodiment of the disclosure, the MAC CE includes information related to k and information related to an identifier of the UCI.

In accordance with another aspect of the disclosure, a base station in a communication system is provided. The base station includes a transceiver and a processor coupled to the transceiver and configured to transmit a configuration associated with a layer 1/layer 2 triggered mobility (LTM) through higher layer signaling, and receive uplink control information (UCI) for a layer 1 measurement report (L1 MR) related to the LTM, wherein the UCI includes information fields for N samples, and wherein an information field for each sample includes 6-bit information indicating a synchronization signal block (SSB) index and 1-bit information corresponding to the SSB index and indicating whether an event condition configured for the L1 MR is satisfied.

According to an embodiment of the disclosure, the UCI includes information fields for N samples, and an information field for one sample includes 6-bit information indicating a synchronization signal block (SSB) index and 1-bit information corresponding to the SSB index and indicating whether an event condition configured for the L1 MR is satisfied.

According to an embodiment of the disclosure, N is defined by Floor {(periodicity configured for the L1 MR)/(SSB measurement timing configuration (SMTC) periodicity)}. When the event condition is for a serving cell, a number of bits of the UCI is 7N, and when the event condition is for a neighbor cell, the number of bits of the UCI is 7NM where M is a number of neighbor cells.

According to an embodiment of the disclosure, the neighbor cell is a candidate target cell for the LTM.

According to an embodiment of the disclosure, whether the event condition is for the serving cell or the neighbor cell is identified based on a condition identifier included in a condition configuration included in the configuration associated with the LTM.

According to an embodiment of the disclosure, the configuration associated with the LTM includes LTM-CSI-ReportConfig.

According to an embodiment of the disclosure, the LTM-CSI-ReportConfig includes a configuration indicating that the 6-bit information and the 1-bit information are included in the UCI.

According to an embodiment of the disclosure, the processor is further configured to receive a medium access control (MAC) control element (CE) indicating transmission of a scheduling request (SR) for the UCI in slot n, receive the SR related to a first uplink grant transmitted after slot n+k, transmit an uplink grant in response to the SR, and receive the UCI related to the uplink grant.

According to an embodiment of the disclosure, the MAC CE includes information related to k and information related to an identifier of the UCI.

Various embodiments of the disclosure can provide a method and apparatus for an enhanced L1 measurement report.

Various embodiments of the disclosure can provide improvements to a mobility procedure.

Other aspects, advantages, and salient features of the disclosure will become apparent to those skilled in the art from the following detailed description, which, taken in conjunction with annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain in a wireless communication system according to an embodiment of the disclosure;

FIG. 2 is a diagram illustrating structures of a frame, a subframe, and a slot in a wireless communication system according to an embodiment of the disclosure;

FIG. 3 is a diagram illustrating an example of a bandwidth part (BWP) configuration in a wireless communication system according to an embodiment of the disclosure;

FIG. 4 is a diagram illustrating radio protocol structures of a base station and a UE in single cell, carrier aggregation, and dual connectivity situations in a wireless communication system according to an embodiment of the disclosure;

FIG. 5 is a diagram illustrating a procedure of an L3 handover according to an embodiment of the disclosure;

FIG. 6 is a diagram illustrating a procedure of an LTM according to an embodiment of the disclosure;

FIG. 7 illustrates an example of a measurement model of a UE according to an embodiment of the disclosure;

FIG. 8 is a diagram illustrating a conventional problem according to an embodiment of the disclosure;

FIG. 9 is a diagram illustrating a conventional problem according to an embodiment of the disclosure;

FIG. 10 illustrates an example of a new UCI format according to an embodiment of the disclosure;

FIG. 11 is a diagram illustrating a technical effect of a new UCI format according to an embodiment of the disclosure;

FIG. 12 is a diagram illustrating an example of a new MAC CE according to an embodiment of the disclosure;

FIG. 13 is a diagram illustrating an LTM procedure according to an embodiment of the disclosure;

FIG. 14 is a diagram illustrating a comparison of HIT between an L3-based handover and an LTM according to an embodiment of the disclosure;

FIG. 15 is a diagram illustrating a handover behavior when a radio channel condition is rapidly deteriorated according to an embodiment of the disclosure;

FIG. 16 is a diagram illustrating an example of a UCI format for L1 MR according to an embodiment of the disclosure;

FIG. 17 is a diagram illustrating an example of link adaptation according to various embodiments of the disclosure;

FIGS. 18A, 18B and 18C are diagrams illustrating an example of an early CSI acquisition operation according to an embodiment of the disclosure;

FIG. 19 illustrates an example of a simulation result related to early CSI acquisition according to an embodiment of the disclosure;

FIG. 20 illustrates an example of a simulation result related to early CSI acquisition according to an embodiment of the disclosure;

FIG. 21 illustrates an example of a simulation result related to early CSI acquisition according to an embodiment of the disclosure;

FIG. 22 is a diagram illustrating an example of an operation of a UE according to an embodiment of the disclosure;

FIG. 23 is a diagram illustrating an example of an operation of a base station according to an embodiment of the disclosure;

FIG. 24 is a diagram illustrating an example of a structure of a UE according to an embodiment of the disclosure; and

FIG. 25 is a diagram illustrating an example of a structure of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some elements in the drawings are exaggerated, omitted, or schematically illustrated. Also, the size of each element does not entirely reflect the actual size. In the drawings, the same or corresponding elements are denoted by the same reference numerals.

The advantages and features of the disclosure and the manner of achieving them will become apparent with reference to embodiments described in detail below and with reference to the accompanying drawings. The disclosure may, however, be embodied in many different forms and should not be construed as being limited to the embodiments set forth herein. Rather, these embodiments are provided so that the disclosure will be thorough and complete and will fully convey the scope of the disclosure to those skilled in the art. The disclosure is only defined by the scope of claims. In the disclosure, the same reference numerals are used to indicate the same elements. In addition, if it is determined that a detailed description of a related function or configuration unnecessarily obscures the subject matter of the disclosure, the detailed description will be omitted. Further, the terms used herein are terms defined in consideration of functions in the disclosure, and may vary according to a user's or operator's intention or customs. Therefore, the definition should be made based on the content throughout the disclosure.

In the disclosure, although the embodiments are described using terms used in some communication standards (e.g., long term evolution (LTE) and new radio (NR) defined by 3rd generation partnership project (3GPP)), this is only for explanation. The embodiments of the disclosure can be easily modified and applied to other communication systems. That is, the disclosure is not limited to the 5G communication system or the LTE communication system, and can also be applied to 6G and subsequent communication systems.

In the disclosure, a base station refers to an entity performing resource allocation of a terminal, and may be at least one of a gNode B (gNB), an eNode B (eNB), a Node B, a base station (BS), a radio access unit, a base station controller, or a node on a network. Also, a terminal may include a user equipment (UE), a mobile station (MS), a cellular phone, a smart phone, a computer, or a multimedia system capable of performing a communication function. In the disclosure, a downlink (DL) refers to a wireless transmission path of a signal transmitted from a base station to a terminal, and an uplink (UL) refers to a wireless transmission path of a signal transmitted from a terminal to a base station. Although embodiments of the disclosure will be described below using an NR system as an example, such embodiments may also be applied to other communication systems having a similar technical background or channel type. In addition, the embodiments of the disclosure may be applied to other communication systems through some modifications within a range that does not significantly depart from the scope of the disclosure as will be apparent to a person skilled in the art.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term ‘unit’ used in embodiments refers to a software or hardware component such as a field programmable gate array (FPGA) or application specific integrated circuit (ASIC), and the ‘unit’ performs certain tasks. However, the ‘unit’ is not limited to software or hardware. The ‘unit’ may be constituted to reside on an addressable storage medium and constituted to execute on one or more processors. Thus, the ‘unit’ may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and ‘units’ may be combined into fewer components and ‘units’ or further separated into additional components and ‘units’. In addition, the components and ‘units’ may be implemented to operate one or more central processing units (CPUs) in a device or a secure multimedia card. Also, in an embodiment, the ‘unit’ may include one or more processors.

Wireless communication systems have expanded beyond the original role of providing a voice-oriented service and have evolved into wideband wireless communication systems that provide a high-speed and high-quality packet data service according to, for example, communication standards such as high-speed packet access (HSPA), long-term evolution (LTE) (or evolved universal terrestrial radio access (E-UTRA)), and LTE-Advanced (LTE-A) of 3GPP, high-rate packet data (HRPD) and a ultra-mobile broadband (UMB) of 3GPP2, and 802.16e of Institute of Electrical and Electronics Engineers (IEEE).

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (or eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since the 5G communication system, which is a communication system subsequent to LTE, should freely reflect various requirements of users, service providers, etc., services satisfying various requirements must be supported. The services considered in the 5G communication system include enhanced Mobile Broadband (eMBB) communication, massive Machine Type Communication (mMTC), Ultra-Reliability Low-Latency Communication (URLLC), and the like.

The eMBB aims at providing a data rate higher than that supported by existing LTE, LTE-A, or LTE-Pro. For example, in the 5G communication system, the eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced Multi-Input Multi-Output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, the mMTC is being considered to support application services such as the Internet of things (IoT) in the 5G communication system. The mMTC has requirements, such as support of connection of a large number of UEs in a cell, enhancement coverage of UEs, improved battery time, a reduction in the cost of a UE, and the like, in order to effectively provide the IoT. Since the IoT provides communication functions while being provided to various sensors and various devices, it must support a large number of UEs (e.g., 1,000,000 UEs/km2) in a cell. In addition, the UEs supporting the mMTC may require wider coverage than those of other services provided by the 5G communication system because the UEs are likely to be located in a shadow area, such as a basement of a building, which is not covered by the cell due to the nature of the service. The UE supporting the mMTC should be configured to be inexpensive, and may require a very long battery life time such as 10 to 15 years because it is difficult to frequently replace the battery of the UE.

Lastly, the URLLC is a cellular-based wireless communication service used for a specific purpose (mission-critical). For example, services such as remote control for robots or machinery, industrial automation, unmanaged aerial vehicles, remote health care, and emergency alert may be considered. Therefore, the communication provided by the URLLC should provide ultra-low latency and ultra-high reliability. For example, a service supporting the URLLC should satisfy an air interface latency of less than 0.5 milliseconds, and also requires a packet error rate of 10-5 or less. Therefore, for services supporting the URLLC, the 5G system should provide a transmit time interval (TTI) smaller than those of other services, and may also require a design for allocating wide resources in the frequency band to secure the reliability of a communication link.

Three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, ‘a/b’ can be understood as at least one of ‘a’ or ‘b’.

Now, a frame structure of the 5G system will be described in detail with reference to the drawings.

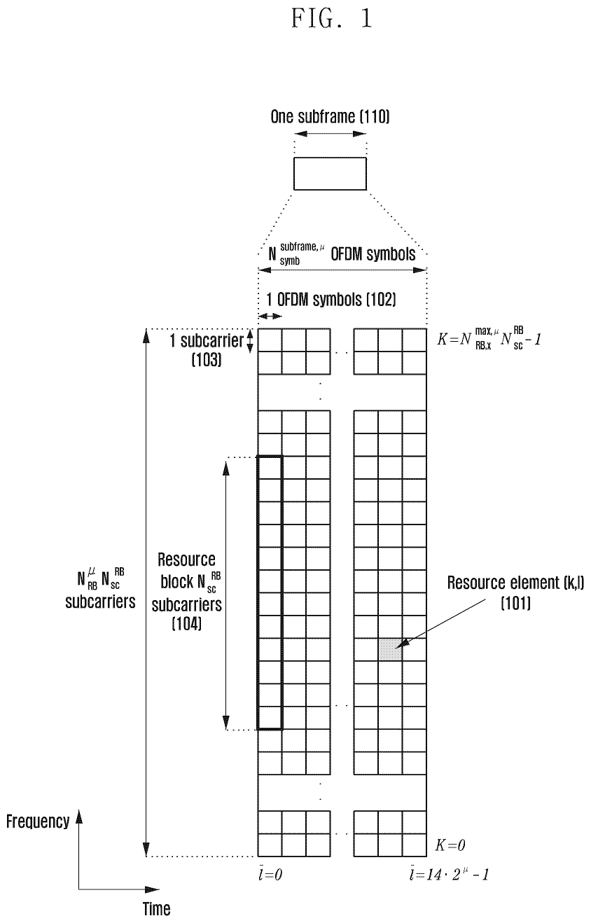

FIG. 1 is a diagram illustrating a basic structure of a time-frequency domain which is a radio resource area where a data or control channel is transmitted in a 5G system according to an embodiment of the disclosure.

The horizontal axis represents a time domain, and the vertical axis represents a frequency domain. A basic unit of resources in the time-frequency domain is a resource element (RE) 101, which may be defined as one OFDM symbol 102 in the time domain and one subcarrier 103 in the frequency domain. In the frequency domain, N_{SC}^{RB} (for example, 12) consecutive REs may constitute one resource block (RB) 104. One subframe 110 on the time axis may include a plurality of OFDM symbols 102. For example, the length of one subframe may be 1 ms.

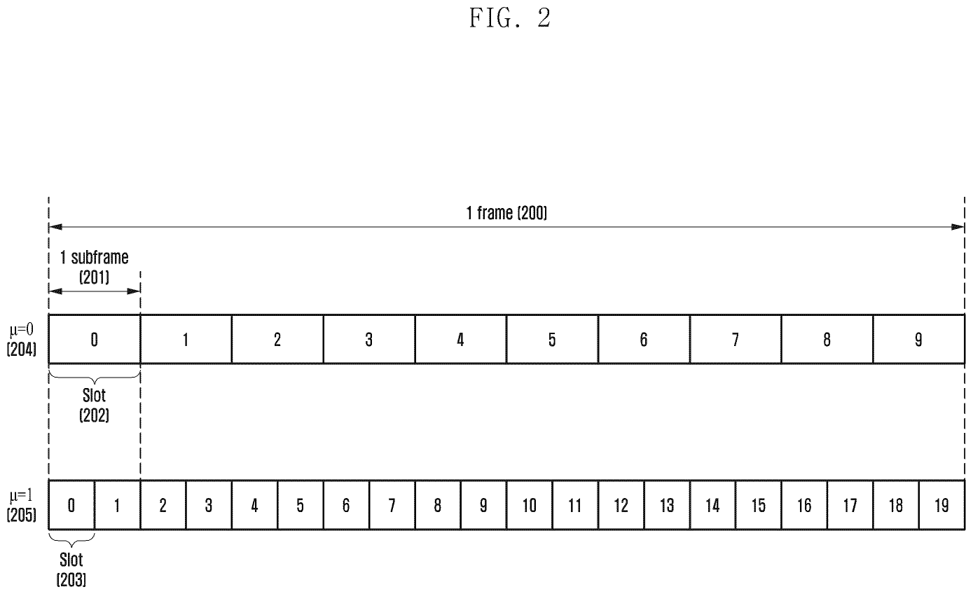

FIG. 2 is a diagram illustrating structures of a frame, a subframe, and a slot in a wireless communication system according to an embodiment of the disclosure.

Referring to FIG. 2, an example of structures of a frame 200, a subframe 201, and a slot 202 is illustrated. One frame 200 may be defined as 10 ms. One subframe 201 may be defined as 1 ms, and thus the one frame 200 may be composed of ten subframes 201. One slot 202 or 203 may be defined as fourteen OFDM symbols (i.e., the number of symbols per slot

$$( {N}_{symb}^{slot} )$$

is 14). One subframe 201 may be composed of one or multiple slots 202 and 203. The number of slots 202 and 203 per one subframe 201 may differ according to configuration value μ 204 or 205 for a subcarrier spacing. In the example of FIG. 2, subcarrier spacing configuration values μ=0 (204) and μ=1 (205) are illustrated. In the case of μ=0 (204), one subframe 201 may be composed of one slot 202. In the case of μ=1 (205), one subframe 201 may be composed of two slots 203. That is, depending on the subcarrier spacing configuration value μ, the number of slots per subframe

$$( {N}_{slot}^{subframe , μ} )$$

may vary, and the number of slots per frame

$$( {N}_{slot}^{frame , μ} )$$

may vary accordingly. The numbers

$${N}_{slot}^{subframe , μ} and {N}_{slot}^{frame , μ}$$

according to each subcarrier spacing configuration u may be defined as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, the configuration of a bandwidth part (BWP) in a 5G communication system will be described in detail with reference to the drawings.

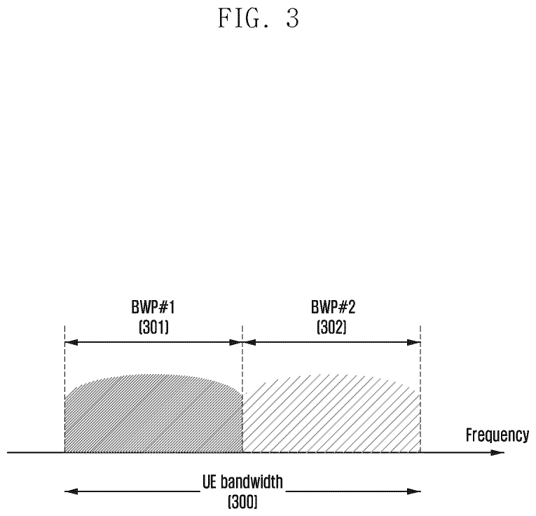

FIG. 3 is a diagram illustrating an example of a BWP configuration in a wireless communication system according to an embodiment of the disclosure.

FIG. 3 illustrates an example in which a UE bandwidth 300 is configured as two BWPs, that is, BWP #1 301 and BWP #2 302. A base station may configure one or multiple BWPs for a UE, and may configure information as shown in Table 2 below for each BWP.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

The BWP configuration is not limited to the above example, and various parameters related to BWP may be configured for the UE in addition to the above configuration information. The above information may be transmitted by the base station to the UE via higher layer signaling, for example, radio resource control (RRC) signaling. At least one of configured one or multiple BWPs may be activated. Whether to activate the configured BWP may be dynamically transmitted via downlink control information (DCI) or semi-statically transmitted via RRC signaling from the base station to the UE.

According to some embodiment, the UE before RRC connection may be configured with an initial BWP for initial access from the base station through a master information block (MIB). Specifically, the UE may receive configuration information about a search apace and a control resource set (CORESET) in which a PDCCH for reception of system information (which may correspond to remaining system information (RMSI) or system information block 1 (SIB 1)) required for initial access may be transmitted through the MIB in an initial access step. The CORESET and search space, which are configured through the MIB, may be regarded as identity (ID) 0, respectively. The base station may notify the UE of configuration information, such as frequency allocation information, time allocation information, and numerology for the CORESET #0, through the MIB. In addition, the base station may notify the UE of configuration information regarding the monitoring periodicity and monitoring occasion for the CORESET #0, that is, configuration information regarding the search space #0, through the MIB. The UE may regard the frequency domain configured with the CORESET #0, obtained from the MIB, as an initial BWP for initial access. Here, the ID of the initial BWP may be regarded as zero.

The configuration for the BWP supported in the 5G may be used for various purposes.

According to some embodiment, in the case where a bandwidth supported by the UE is less than a system bandwidth, this may be supported through the BWP configuration. For example, the base station may configure, for the UE, a frequency location (configuration information 2) of the BWP to enable the UE to transmit or receive data at a specific frequency location within the system bandwidth.

In addition, according to some embodiment, the base station may configure multiple BWPs for the UE for the purpose of supporting different numerologies. For example, in order to support data transmission/reception to/from a certain UE using both a subcarrier spacing of 15 kHz and a subcarrier spacing of 30 kHz, the base station may configure two BWPs with the subcarrier spacing of 15 kHz and the subcarrier spacing of 30 kHz, respectively. Different BWPs may be frequency division multiplexed (FDM), and when the base station attempts to transmit or receive data at a specific subcarrier spacing, the BWP configured with the corresponding subcarrier spacing may be activated.

In addition, according to some embodiment, the base station may configure, for the UE, the BWPs having bandwidths of different sizes for the purpose of reducing power consumption of the UE. For example, when the UE supports a very large bandwidth (e.g., a bandwidth of 100 MHZ) and always transmits or receives data at that bandwidth, there may arise very high power consumption. In particular, when there is no traffic, monitoring on an unnecessary downlink control channel in a large bandwidth of 100 MHz may be very inefficient in terms of power consumption. Therefore, in order to reduce power consumption of the UE, the base station may configure, for the UE, a BWP of a relatively small bandwidth (e.g., a BWP of 20 MHz). In a situation without traffic, the UE may perform a monitoring operation on a BWP of 20 MHZ, and when there is data to be transmitted or received, the UE may transmit or receive data in a BWP of 100 MHz in response to an indication of the base station.

In a method of configuring the BWP, the UEs before the RRC connection may receive configuration information about the initial BWP through the MIB in the initial access step. Specifically, the UE may be configured with a CORESET for a downlink control channel in which DCI for scheduling a system information block (SIB) may be transmitted from the MIB of a physical broadcast channel (PBCH). The bandwidth of the CORESET configured through the MIB may be regarded as the initial BWP. Through the configured initial BWP, the UE may receive a physical downlink shared channel (PDSCH) in which the SIB is transmitted. The initial BWP may be used for other system information (OSI), paging, and random access as well as the reception of the SIB.

In the case where one or more BWPs are configured for the UE, the base station may indicate a change (or switching, transition) of the BWP to the UE by using a BWP indicator field in the DCI. For example, in FIG. 3, when the currently activated BWP of the UE is BWP #1 301, the base station may indicate BWP #2 302 to the UE by using the BWP indicator in the DCI, and the UE may perform the BWP switch to the BWP #2 302 indicated by the BWP indicator in the received DCI.

As described above, since the DCI-based BWP switch may be indicated by the DCI for scheduling PDSCH or PUSCH, the UE should be able to smoothly receive or transmit the PDSCH or PUSCH, which is scheduled by the DCI, without difficulty in the switched BWP when receiving a request for the BWP switch. For this purpose, the standard stipulates requirements for a delay time (TBWP) required when switching the BWP, as defined in Table 3, for example.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the BWP switch delay time may support type 1 or type 2 depending on UE capability. The UE may report a supportable BWP delay time type to the base station.

When the UE receives the DCI including the BWP switch indicator in slot n according to the requirements for the BWP switch delay time, the UE may complete a switch to a new BWP indicated by the BWP switch indicator at a time not later than slot n+T_{BWP}, and may perform transmission and reception for a data channel scheduled by the DCI in the switched new BWP. When the base station intends to schedule the data channel to the new BWP, the base station may determine a time domain resource allocation for the data channel by considering the BWP switch delay time (T_{BWP}) of the UE. That is, when the base station schedules the data channel to the new BWP, the base station may schedule the data channel after the BWP switch delay time in a method for determining the time domain resource allocation for the data channel. Thus, the UE may not expect that the DCI indicating the BWP switch will indicate a slot offset (K0 or K2) value less than the T_{BWP}.

If the UE receives the DCI (e.g., DCI format 1_1 or 0_1) indicating the BWP switch, the UE may not perform any transmission or reception during a time interval from the third symbol of the slot in which the PDCCH including the DCI is received to the start point of the slot indicated by the slot offset (K0 or K2) value indicated by the time domain resource allocation indicator field in the DCI. For example, if the UE has received the DCI indicating the BWP switch in slot n and the slot offset value indicated by the DCI is K, the UE may not perform any transmission or reception from the third symbol of the slot n to the symbol prior to slot n+K (i.e., the last symbol of slot n+K−1).

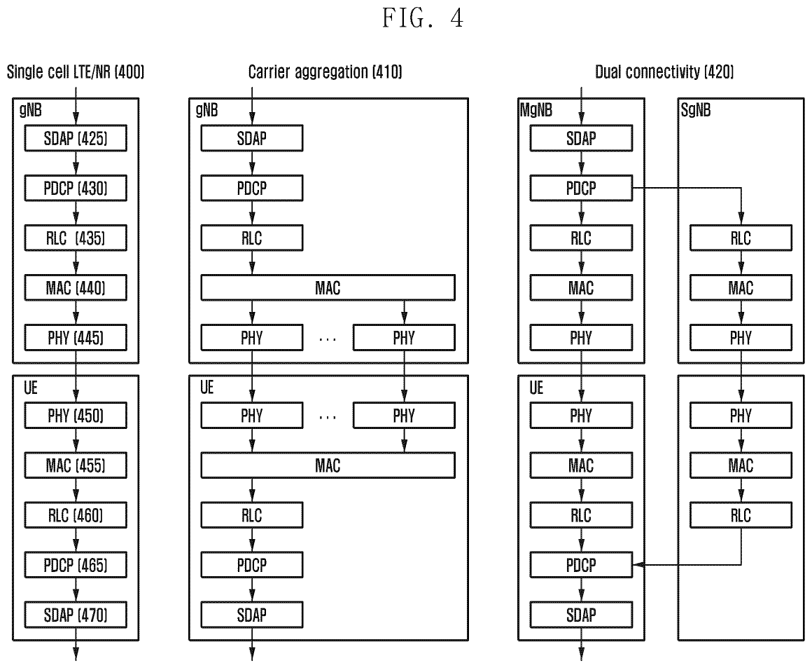

FIG. 4 is a diagram illustrating radio protocol structures of a base station and a UE in single cell, carrier aggregation, and dual connectivity situations according to an embodiment of the disclosure.

Referring to FIG. 4, in each of a UE and an NR base station (gNB), the radio protocols of the next-generation mobile communication system include NR service data adaptation protocol (SDAP) 425 or 470, NR packet data convergence protocol (PDCP) 430 or 465, NR radio link control (RLC) 435 or 460, and NR medium access control (MAC) 440 or 455.

The main functions of the NR SDAP 425 or 470 may include some of the following functions.
User data transmission function (Transfer of user plane data)
Function of mapping a QoS flow and a data bearer for uplink and downlink (Mapping between a QoS flow and a data ratio bearer (DRB) for both DL and UL)
Function of marking a QoS flow ID in uplink and downlink (Marking QoS flow ID in both DL and UL packets)
Function of mapping a reflective QoS flow to a data bearer for uplink SDAP PDUs (Reflective QoS flow to DRB mapping for the UL SDAP PDUs)

With respect to an SDAP layer device, the UE may be configured through an RRC message whether or not to use a header of the SDAP layer device or whether or not to use a function of the SDAP layer device, for each PDCP layer device, each bearer, or each logical channel. If the SDAP header is configured, a 1-bit indicator of non-access stratum (NAS) reflective QoS of the SDAP header and a 1 bit-indicator of (access stratum (AS) reflective QoS may indicate that the UE can update or reconfigure mapping information about a QoS flow and a data bearer in uplink and downlink. The SDAP header may include QoS flow ID information indicating the QoS. The QoS information may be used as data processing priority, scheduling information, etc. to support a seamless service.

The main functions of the NR PDCP 430 or 465 may include some of the following functions.
Header compression and decompression function (Header compression and decompression: ROHC only)
User data transmission function (Transfer of user data)
Sequential delivery function (In-sequence delivery of upper layer PDUs)
Non-sequential delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU removal function (Timer-based SDU discard in uplink)

In the above description, the reordering function of the NR PDCP device may refer to a function of sequentially reordering PDCP PDUs received from a lower layer on the basis of a PDCP sequence number (SN). The reordering function of the NR PDCP device may include a function of sequentially transferring the reordered data to an upper layer, a function of directly transferring the reordered data without regard to the order, a function of recording lost PDCP PDUs by reordering, a function of reporting the statuses of the lost PDCP PDUs to a transmitting side, or a function of requesting retransmission of the lost PDCP PDUs.

The main functions of the NR RLC 435 or 460 may include some of the following functions.
Data transmission function (Transfer of upper layer PDUs)
Sequential delivery function (In-sequence delivery of upper layer PDUs)
Non-sequential delivery function (Out-of-sequence delivery of upper layer PDUs)
ARQ function (Error correction through ARQ)
Concatenation, segmentation, and reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU removal function (RLC SDU discard)
RLC re-establishment function (RLC re-establishment)

In the above description, the sequential delivery function (In-sequence delivery) of the NR RLC device refers to a function of sequentially transferring RLC PDUs received from a lower layer to an upper layer. In the case where one original RLC SDU is divided into a plurality of RLC SDUs and received, the sequential delivery function may include a function of reassembling and transmitting the RLC SDUs, a function of reordering the received RLC PDUs on the basis of an RLC sequence number (SN) or a PDCP SN, a function of recording lost RLC PDUs by reordering, a function of reporting the statuses of the lost RLC PDUs to a transmitting side, and a function of requesting retransmission of the lost RLC PDUs. In the case that there is a lost RLC SDU, the sequential delivery function may include a function of sequentially transferring only RLC SDUs preceding the lost RLC SDU to the upper layer, or if a predetermined timer expires even when there is a lost RLC SDU, the sequential delivery function may include a function of sequentially transferring all RLC SDUs received before the timer starts to the upper layer, or a function of sequentially transferring all RLC SDUs received up to that point in time to the upper layer. In addition, the RLC PDUs may be processed in the order in which they are received (in the order of arrival, regardless of the order of sequence numbers) and delivered to the PDCP device out of order (Out-of-sequence delivery). In the case of segments, the segments stored in the buffer or to be received later may be received, reassembled into a complete one RLC PDU, processed, and delivered to the PDCP device. The NR RLC layer may not include a concatenation function, and this function may be performed in the NR MAC layer or replaced with a multiplexing function of the NR MAC layer.

In the above description, the non-sequential delivery function (Out-of-sequence delivery) of the NR RLC device refers to a function of transferring RLC SDUs received from a lower layer directly to an upper layer regardless of the order of the RLC SDUs. In the case where one original RLC SDU is divided into a plurality of RLC SDUs and received, the non-sequential delivery function of the NR RLC device may include a function of reassembling and transmitting the RLC SDUs, and a function of storing RLC SNs or PDCP SNs of the received RLC PDUs, reordering them, and recording lost RLC PDUs.

The NR MAC 440 or 455 may be connected to a plurality of NR RLC layer devices composed in one apparatus, and main functions of the NR MAC may include some of the following functions.
Mapping function (Mapping between logical channels and transport channels)
Multiplexing and demultiplexing function (Multiplexing/demultiplexing of MAC SDUs)
Scheduling information reporting function (Scheduling information reporting)
HARQ function (Error correction through HARQ)
Logical channel priority control function (Priority handling between logical channels of one UE)
UE priority control function (Priority handling between UEs by means of dynamic scheduling)
MBMS service identification function (MBMS service identification)
Transport format selection function (Transport format selection)
Padding function (Padding)

The NR PHY layer 445 or 450 may perform operations of channel-coding and modulating upper layer data to generate an OFDM symbol and transmitting it through a radio channel or demodulating and channel-decoding an OFDM symbol received through a radio channel and transmitting it to an upper layer.

The above radio protocol structure may have various detailed structures that vary depending on a carrier (or cell) operation scheme. For example, if the base station transmits data to the UE based on a single carrier (or cell), the base station and the UE use a protocol structure having a single structure for each layer as denoted by 400. On the other hand, if the base station transmits data to the UE based on carrier aggregation (CA) that uses multiple carriers in a single TRP, the base station and the UE use a protocol structure having a single structure up to the RLC but multiplexing the PHY layer through the MAC layer as denoted by 410. In addition, if the base station transmits data to the UE based on dual connectivity (DC) that uses multiple carriers in multiple TRPs, the base station and the UE use a protocol structure having a single structure up to the RLC but multiplexing the PHY layer through the MAC layer as denoted by 420.

Hereinafter, embodiments of the disclosure will be described in detail with reference to the accompanying drawings. The disclosure can be applied to FDD, TDD and/or XDD (and/or SBFD, full duplex) systems. In the following description, upper signaling (or higher layer signaling) refers to a signal transmission method in which a base station transmits a signal to a UE via a downlink data channel of a physical layer, or a UE transmits a signal to a base station via an uplink data channel of a physical layer, and may also be referred to as RRC signaling, PDCP signaling, or medium access control (MAC) control element (CE).

In the following description, a base station refers to an entity performing resource allocation of a terminal, and may be at least one of a gNode B (gNB), an eNode B (eNB), a Node B, a base station (BS), a radio access unit, a base station controller, or a node on a network. Also, a terminal may include a user equipment (UE), a mobile station (MS), a cellular phone, a smart phone, a computer, or a multimedia system capable of performing a communication function. Hereinafter, embodiments of the disclosure will be described using the 5G system as an example, but the embodiments may also be applied to other communication systems having a similar technical background or channel type, such as LTE or LTE-A mobile communication and mobile communication technologies developed after 5G. Accordingly, the embodiments of the disclosure may be applied to other communication systems through some modifications without significantly departing from the scope of the disclosure as will be apparent to a person skilled in the art.

In the following description of the disclosure, a detailed description of known functions or components will be omitted when it may make the subject matter of the disclosure unnecessarily unclear. The terms which will be described below are terms defined in consideration of the functions in the disclosure, and may be varied according to users, intentions of operators, or customs. Therefore, the definitions of the terms should be made based on the contents throughout the description.

In the following description of the disclosure, higher layer signaling may be signaling corresponding to at least one or a combination of one or more of the following signaling.
MIB (Master Information Block)
SIB (System Information Block) or SIB X (X=1, 2, . . . )
RRC (Radio Resource Control)
MAC (Medium Access Control) CE (Control Element)

In addition, L1 signaling may be signaling corresponding to at least one or a combination of one or more of signaling methods using the following physical layer channels or signaling.
PDCCH (Physical Downlink Control Channel)
DCI (Downlink Control Information)
UE-specific DCI
Group common DCI
Common DCI
Scheduling DCI (e.g., DCI used for the purpose of scheduling downlink or uplink data)
Non-scheduling DCI (e.g., DCI not used for the purpose of scheduling downlink or uplink data)
PUCCH (Physical Uplink Control Channel)
UCI (Uplink Control Information)

Hereinafter, the term slot used in the disclosure is a general term that refers to a specific time unit corresponding to a transmit time interval (TTI), and specifically may refer to a slot used in the 5G NR system, or refer to a slot or a subframe used in the 4G LTE system. Or, it may refer to a time resource unit used in the 6G system.

In the disclosure, the above examples are described through many embodiments, but they are not independent, and two or more embodiments can be applied simultaneously or in combination.

In the wireless communication system, schemes of supporting a mobility management method, including handover, and also reducing an interruption time that may occur at this time have been proposed. For example, there is a scheme called conditional handover (CHO). However, since DL synchronization and UL synchronization occupy a large portion of the interruption time, the effect of methods proposed to reduce the interruption time, such as the CHO, may be minimal.

Accordingly, L1/L2 triggered mobility (LTM) has been designed to reduce the interruption time.

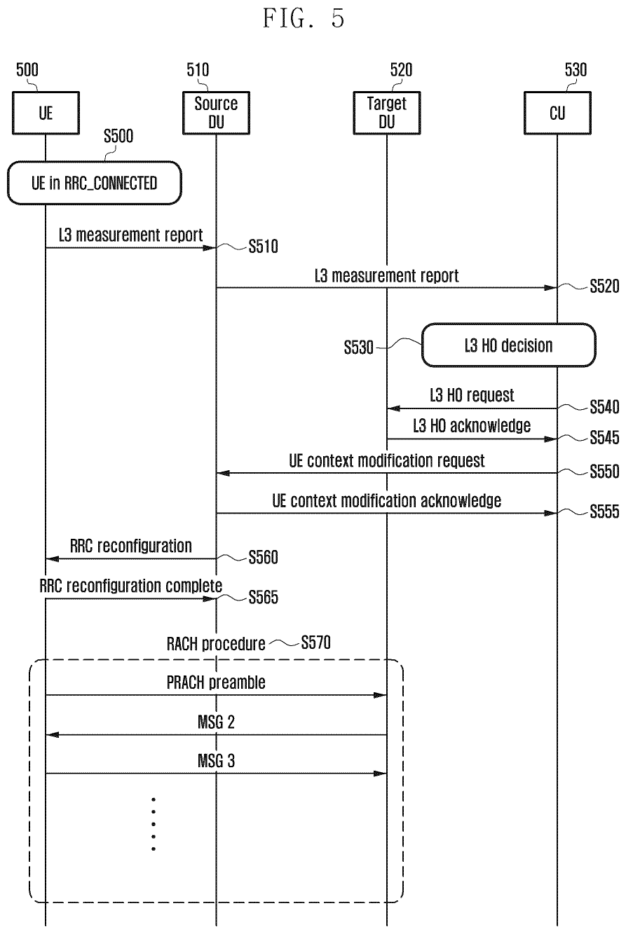

FIG. 5 is a diagram illustrating a procedure of an L3 handover according to an embodiment of the disclosure.

To summarize the L3 handover procedure according to an embodiment, as illustrated in FIG. 5, a UE 500 which is in a radio resource control (RRC) connected state in S500 may transmit an L3 measurement report to a source distributed unit (DU) 210 in S510. For example, the UE 500 may perform measurement on at least one neighbor cell and report the measurement result.

In step S520, the L3 measurement report may be transmitted from the source DU 510 to a centralized unit (CU) 530.

In step S530, if an L3 handover is determined by the CU 530 based on the L3 measurement report, the CU 530 may transmit an L3 HO request to a target DU 520 in S540. Then, in S545, the target DU 520 may transmit an L3 HO acknowledge to the CU 530.

In step S550, the CU 530 may transmit a UE context modification request to the source DU 510, and in step S555, the source DU 510 may transmit a UE context modification acknowledge to the CU 530.

In addition, the source DU 510 may transmit an RRC reconfiguration message to the UE 500 in step S560, and the UE 500 may transmit an RRC reconfiguration completion message to the source DU 510 in step S565. Then, in step S570, an RACH procedure may be performed. The RACH procedure of S570 may include steps of transmitting a PRACH preamble to the target DU 520 at the UE 500, receiving MSG2 from the target DU 520 at the UE 500, transmitting MSG3 to the target DU 520 at the UE 500, and the like.

In this L3 HO of FIG. 5, an interruption time may occur in a process of the UE performing DL synchronization and UL synchronization procedures with the target DU after receiving an HO command based on the RRC reconfiguration message.

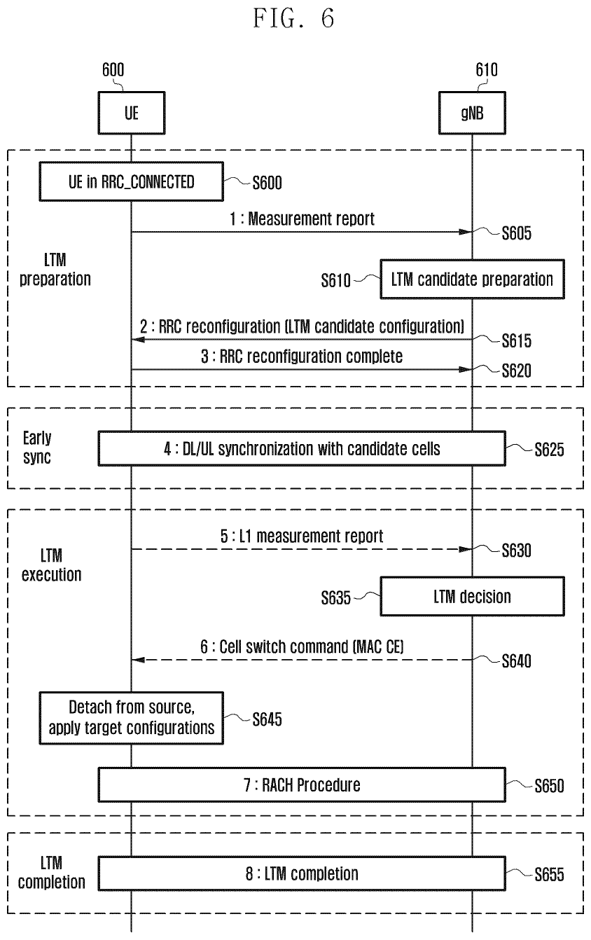

FIG. 6 is a diagram illustrating a procedure of an LTM according to an embodiment of the disclosure.

Based on FIG. 6, the LTM procedure is summarized. A UE 600 which is in an RRC connected state in S600 may transmit a measurement report to a base station 610 in S605. The base station 610 may be an NR base station such as a gNB. According to an embodiment, the base station 610 may be composed of one CU and a plurality of DUs (e.g., a source DU and a target DU).

In step S610, the base station 610 may perform an LTM candidate preparation procedure. In addition, the base station 610 may transmit information about LTM candidate configuration through an RRC reconfiguration message in S615. For example, the base station 610 may generate the information about LTM candidate configuration through the LTM candidate preparation procedure and transmit the generated information about LTM candidate configuration to the UE 600.

The UE 600 that receives the RRC reconfiguration message may transmit an RRC reconfiguration complete message to the base station 610. Here, the steps S605 to S620 may be the LTM preparation procedure.

In step S625 which is an early synchronization procedure, and the UE 600 may perform DL/UL synchronization with at least one candidate cell. For example, the UE 600 may identify at least one candidate cell based on the information about LTM candidate configuration received from the base station 610 in the S615, and perform the DL/UL synchronization with the at least one candidate cell.

In step S630, the UE 600 may transmit an L1 measurement report to the base station 610. When an LTM decision is performed by the base station 610 in step S635, the base station 610 may transmit a cell switch command to the UE 600 via a MAC CE in step S640. The UE 600 that receives the MAC CE may be detached from a source and apply target configurations in step S645. In step S650, the UE 600 may perform a RACH procedure. The steps S630 to S650 may be an LTM execution procedure.

In step S655, the LTM may be completed through an LTM completion procedure.

As described above, the LTM procedure includes four steps: 1) preparation, 2) early synchronization, 3) execution, and 4) completion.

1) LTM Preparation: The serving DU provides an RRC reconfiguration for triggering event-based L3 measurement report (MR) to determine potential candidate target cells. For example, in case of mobility within the same frequency (i.e., intra-frequency mobility), the serving cell is able to utilize A3 event triggered when a neighbor cell becomes offset better than the serving cell. If the UE transmits the L3 MR, the serving CU decides whether the LTM candidate cell preparation will be performed or not. When the LTM candidate cell preparation is determined, the serving CU requests the LTM configuration information to be used for pre-processing at the UE to the candidate target DU. The LTM candidate configuration received from a target DU and the L1 MR configuration information indicating the reference signal received powers (RSRPs) of serving cell and candidate target cell(s) are transmitted to the UE through the RRC reconfiguration procedure in step S615.

2) Early Synchronization: In the LTM, a handover interruption time (HIT) is significantly reduced by DL/UL early synchronization procedure. DL synchronization for candidate cell(s) is performed based on synchronization signal block (SSB). For UL synchronization, two types of timing advance (TA) measurement are supported. First, physical random access channel (PRACH)-based TA measurement is triggered by a PDCCH order which includes target cell identity (ID), preamble index, RACH occasion, etc. Then, the target cell measures the TA value, and transfers it to the serving DU. Second, in UE-based TA measurement, the UE obtains the TA based on the receive timing difference between the current serving cell and the candidate target cell as well as TA value for the current serving cell. Considering that the UE capability generally does not support transmission both PRACH and physical uplink shared channel (PUSCH) simultaneously, it is expected that the UE-based TA measurement is more efficient in terms of resource utilization.

3) LTM Execution: The serving DU determines whether to switch the cell based on the periodic L1 MR which is applied only L1 filtered value. Although L1 measurement is filtered at the UE with a finite impulse response (FIR) filter in order to reduce the fluctuation caused by channel characteristics, higher number of ping-pongs (PPs) and handovers may occur due to absence of several features performed previously by L3 layer. Therefore, for more robust mobility decision, applied features in the L3 layer of the UE side such as time-to-trigger (TTT) and average filtered L3 measurement should be considered to the L1/L2 layer. If the serving DU determines to trigger the handover, the serving DU sends the cell switch command message to the UE via MAC CE which contains the TA value to be applied at the target cell.

4) LTM completion: After receiving the cell switch command message, the UE detaches from the source cell and applies the configuration of the target cell received in advance in step S615. If the UE obtains the valid TA value through MAC CE or UE-based TA measurement in advance, the RACH procedure is skipped. Otherwise, the RACH procedure is performed, and the HIT is significantly increased compared to using the early synchronization method. Then, the cell switch completion message is transmitted to the target DU through first UL grant.

Referring to FIG. 6, in the LTM, the UE 600 can synchronize in advance through the early synchronization procedure before receiving the cell switch command, so that the interruption time can be reduced.

In addition, the LTM has an advantage that it does not require L3 layer processing compared to L3 HO because the cell switch command is transmitted through MAC CE based on L1 measurement report (e.g., because the command message is generated in the MAC layer).

Meanwhile, the network can configure the LTM and the L3 handover for any UE simultaneously. Since the LTM and the L3 handover are performed at the network level, the UE needs to manage the priority between the LTM and the L3 handover. In general, the priority between the LTM and the L3 handover may be configured in three situations, as follows.

1. When the L3 handover is performed before the LTM (e.g., when the UE receives the L3 handover command message before the gNB-DU transmits the LTM cell switch command MAC CE), the L3 handover has a higher priority.

2. When the LTM is performed before the L3 handover (e.g., when the UE receives an LTM notify message before the gNB-CU transmits the L3 handover command message), the LTM has a higher priority.

3. When the LTM and the L3 handover are performed almost simultaneously (e.g., when the UE receives the L3 handover command message after the gNB-DU transmits the LTM cell switch command MAC CE), the LTM has a higher priority.

The above-described LTM procedure may be considered as a baseline mobility scheme in 6G. In the LTM, the interruption time can be reduced by DL/UL early synchronization. In addition, since the cell switch decision is made at the DU, it is not affected by a wired section delay between the CU and the DU. In the LTM procedure, the base station receives the L1 measurement report from the UE and, based on this, transmits the cell switch command through MAC CE to change the serving cell of the UE. In the LTM, the UE is allowed to skip the random access procedure for the target cell in case of cell switching (i.e., RACH-less LTM). The UE can determine whether to trigger the RACH-less LTM if the TA value is indicated in the cell switch command through MAC CE.

As described above, in the case of legacy mobility scheme, whether to perform a handover is determined based on the L3 measurement report (MR).

An example of RRC configuration for the L3 MR is shown in Table 4.

TABLE 4

```
reportConfig reportConfigNR :
  reportType eventTriggered :
    eventId eventA3 :
          a3-Offset rsrp : 6,
          reportOnLeave FALSE,
          hysteresis 4,
          timeToTrigger ms480,
          useWhiteCellList FALSE
        ,
    rsType ssb,
    reportInterval ms240,
    reportAmount r8,
    reportQuantityCell
      rsrp TRUE,
      rsrq TRUE,
      sinr FALSE
```

As shown in Table 4, the RRC configuration for the L3 MR may include timeToTrigger (TTT). In the L3 MR, the influence of channel fluctuation is minimized through L3 filtering function, and ping-pong phenomenon is minimized through TTT function. Definitions of L3 filtering and TTT is shown in Table 5.

TABLE 5

```
- TTT: The IE TimeToTrigger specifies the value range used for time to
  trigger parameter, which concerns the time during which specific criteria
  for the event needs to be met in order to trigger a measurement report.
- Layer 3 filtering: Filter the measured result, before using for evaluation of
  reporting criteria or for measurement reporting, by the following formula:
  ▪ Fₙ = (1 − α)Fₙ₋₁ + α · Mₙ
  ▪ Mₙ: The latest received measurement result from the physical layer
  ▪ Fₙ: The updated filtered measurement result, that is used for evaluation
    of reporting criteria or for measurement reporting;
  ▪ Fₙ₋₁: The old filtered measurement result
  ▪ α: Filter coefficient for the corresponding measurement quantity
    received by the quantityConfig
```

On the other hand, in the LTM, the handover decision is performed based on L1-filtered measurement. The exact filtering scheme in L1 filtering depends on implementation, and the standard does not specify how the measurement is actually made at the physical layer. For the L1 MR, the report quantity may typically be layer 1-reference signal received power (L1-RSRP). For example, the L1-RSRP may be synchronization signal (SS)-RSRP or channel state information (CSI)-RSRP, and in Release 18-based LTM, the L1-RSRP may be SS-RSRP.

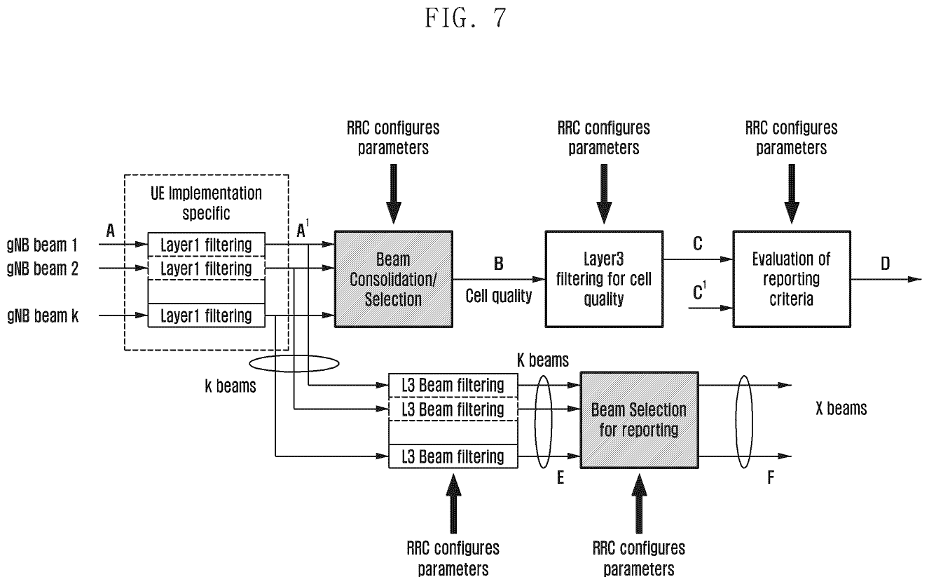

FIG. 7 illustrates an example of a measurement model of a UE according to an embodiment of the disclosure.

In the RRC_CONNECTED state, the UE can measure multiple beams of one or more cells and calculate cell quality by averaging these measurement results (power values). In this process, the UE may be configured to consider only a subset of detected beams.

Filtering may be performed at two levels: filtering for calculating beam quality at the physical layer, and filtering for calculating cell quality from multiple beams at the RRC level.

The cell quality obtained through beam measurement may be calculated in the same way for both the serving cell and the non-serving cell. If the UE is configured for this by the base station, the measurement report may include measurement results for X beams with the highest quality.

Referring to FIG. 7, K beams are configured for L3 mobility by the base station and may correspond to SSB or channel state information reference signal (CSI-RS) resources measured at L1 of the UE. ‘A’ denotes a beam-by-beam measurement sample inside the physical layer. L1 filtering is L1 internal filtering for the measured input A, and a filtering scheme may vary depending on implementation. ‘A1’ denotes a beam-by-beam measurement reported to L3 after the L1 filtering. Beam consolidation/selection is to consolidate beam-by-beam measurements and convert them into cell quality, and it may be configured via RRC signaling. ‘B’ denotes a cell quality measurement value reported at L3 after the beam consolidation/selection. L3 filtering is filtering performed based on the cell quality measurement value (B), and it may be configured via RRC signaling. ‘C’ denotes a measurement value after the L3 filtering, and it may be used as an input for evaluation of reporting criteria. The evaluation of reporting criteria is to determine whether a measurement report is actually required, and the evaluation may be performed based on various measurement flows such as C, C1, etc. ‘D’ denotes measurement report information transmitted via a wireless interface. L3 beam filtering is filtering for beam-by-beam measurements provided from A1, and it may be configured via RRC signaling. ‘E’ denotes a measurement result after the beam filtering, and it may be used as an input for selecting X beam measurements to be reported. Beam selection for beam reporting is to select X measurement values at point E. ‘F’ denotes a measurement report transmitted via a wireless interface. For the L3 MR, a corresponding value may be reported in D, and for the L1 MR, a value corresponding to A1 may be reported.

The following describes the event-triggered L1 measurement report. Information reported through the L1 MR may be transmitted through uplink control information (UCI). The UCI may be configured to be reported periodically/semi-statically through RRC configuration, or may be triggered by the base station and reported. Accordingly, the base station can know at what timing the UCI is transmitted, and also knows the format of the UCI in advance, so it can decode the UCI at the PHY layer without a separate indicator. However, in recent Release 19, event-triggered L1 MR is being considered to improve the L1 MR. In the event-triggered L1 MR, the base station may configure a specific condition to the UE, and the UE may perform a report when the specific condition is satisfied. Thus, it may be difficult for the base station to know in advance what format of the UCI will be transmitted from the UE.

Meanwhile, in the case of legacy UE, subsequent releases can be supported through software upgrades, etc., but even through software upgrades, related functions may not be supported depending on the hardware capabilities.

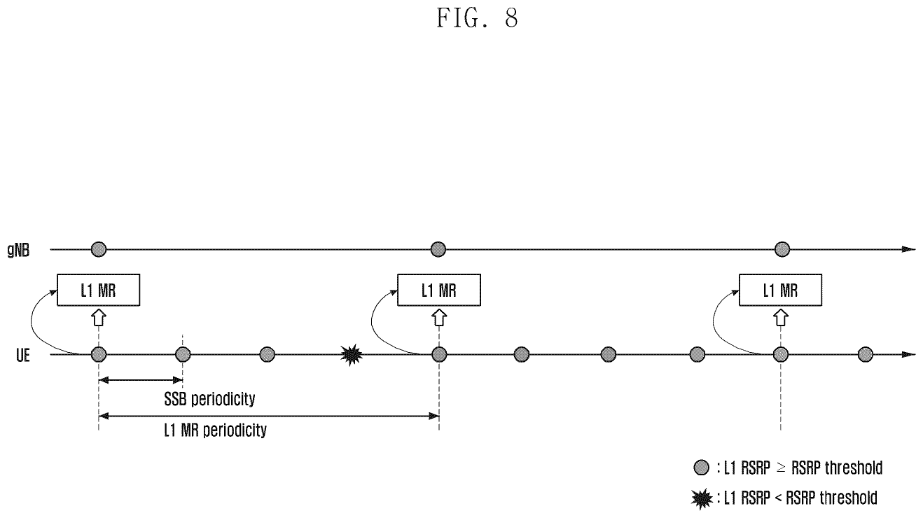

FIG. 8 is a diagram illustrating a conventional problem according to an embodiment of the disclosure.

In the LTM, functions such as L3 filtering and TTT are essential for handover decision, and they may be applied and used at the base station side, not the UE side. In this case, in order to increase handover robustness by applying L3 filtering and TTT, each measurement result should be reported from the UE through L1 MR, which causes high uplink overhead. This is because a conventional UCI format for the L1 MR composed of a total of 13 bits including 6 bits for the SSB index indicating the measurement target and 7 bits for the RSRP measurement value, and the total uplink overhead increases in proportion to the number of measurement target cells and the number of resources to be reported per cell.

On the other hand, if L1 MR periodicity is configured relatively long compared to signal measurement periodicity in order to reduce the amount of uplink overhead, the handover robustness deteriorates. The example of FIG. 8 shows a case where the transmission periodicity of SSB, which is a reference signal for signal measurement, is 10 ms and the L1 MR periodicity is 40 ms. In this case, the fourth measurement value is not reported to the base station because it does not satisfy the condition for handover decision or is not aligned with the L1 MR reporting time. In other words, an L1 measurement value that the base station does not recognize occurs, which may trigger an early handover when making a handover decision, resulting in a ping-pong problem or a handover failure phenomenon.

That is, for the handover robustness, the base station should be aware of all measurement values of the UE. For operations such as TTT to be applied, the base station should be aware of all measurement values. However, since this causes uplink overhead, the L1 MR periodicity and the handover robustness are trade-offs. For example, if the L1 MR periodicity and the measurement periodicity are the same, the uplink overhead increases, but the handover robustness is enhanced, and if the L1 MR periodicity is longer than the measurement periodicity, the uplink overhead decreases, but the handover robustness is reduced. The L1 MR can report only recent measurement values. If the L1 MR periodicity is longer than the SSB periodicity, the base station cannot know anything other than the measurement values reported by the L1 MR. In the example of FIG. 8, the SSB periodicity is 10 ms, the L1 MR periodicity is 40 ms, and in this case, the base station does not know three measurement values existing in the middle. That is, if there is a change in beam quality that is not reported by the UE, the base station may not be able to make an appropriate handover decision.

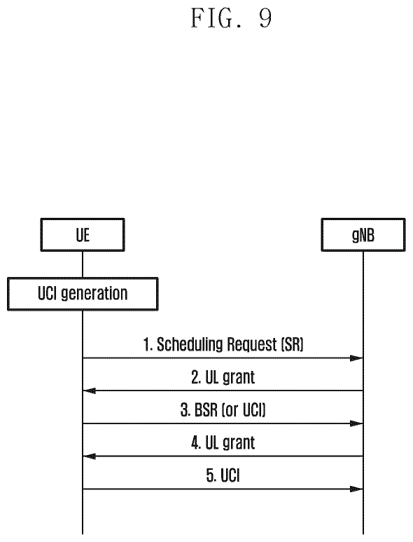

FIG. 9 is a diagram illustrating a conventional problem according to an embodiment of the disclosure.

When the L1 MR is triggered based on an event trigger, the base station (gNB) does not know when the UE will transmit the L1 MR. Therefore, the base station cannot allocate uplink resources in advance, and the UE transmits a scheduling request (SR) to request uplink resource allocation for L1 MR transmission. With reference to FIG. 9, the UE may transmit a scheduling request for uplink resource allocation after UCI generation. The base station may allocate uplink resources through an uplink grant. The UE may transmit a buffer status report (BSR) (and/or UCI). The base station may allocate uplink resources through an uplink grant. The UE may transmit the UCI through the uplink grant. However, the SR operation is triggered by data having a specific logical channel ID, and in the case of the L1 MR, a logical channel ID is not assigned because of the UCI. That is, the SR is not triggered for UCI transmission under the existing 5G standard. Therefore, in the existing 5G standard, the scheduling request cannot be transmitted to request uplink resource allocation for L1 MR transmission as exemplified in FIG. 9.

Meanwhile, in order to decode the received UCI (i.e., the L1 MR), the base station should know in advance what format of UCI is transmitted. However, since the base station has no way of knowing what format of event-triggered L1 MR is transmitted, the base station cannot perform normal decoding.

In addition, if an uplink grant size for the SR is allocated only on the level of being able to transmit the BSR in the procedure of FIG. 9, the size of data to be transmitted in uplink is reported through the BSR. However, since the BSR reflects the size only for data in RLC/PDCP, the UCI size cannot be reported.

As described above, legacy UEs can support subsequent Releases through software upgrades. That is, UEs launched before Release 18 can support LTM introduced in Release 18 through software upgrades. Here, MAC CE and physical random access channel (PRACH)-based early synchronization operations including a cell switch command can be supported. However, the L1 MR function may be difficult to support depending on the hardware capabilities of legacy UEs. Since the handover decision is made based on the L1 MR due to the characteristics of the LTM procedure, the LTM function cannot be practically used in the case of legacy UEs.

Various embodiments of the disclosure are directed to solving the above-described problems, and include embodiments related to the following:
1. Enhanced L1 measurement reporting
2. Improvements for upcoming event-triggered L1 MR
   Improved scheduling request for event-triggered L1 MR
   MAC CE for event-triggered L1 MR
3. LTM support method for legacy UEs

Hereinafter, various embodiments of the disclosure will be described in more detail. The following embodiments of the disclosure are not independent, and two or more embodiments may be applied simultaneously or in combination.

### 1. New UCI Format for L1 MR

According to an embodiment of the disclosure, a new UCI format can be proposed. The new UCI format may be for reducing uplink feedback overhead for the L1 MR and enhancing handover robustness. According to an embodiment of the disclosure, the new UCI includes the following information.

(1) Best SSB Index (6 bits)

Index of the SSB with the highest measurement value (e.g., reference signal received power (RSRP) or signal to interference noise ratio (SINR))

### (2) 1-Bit Flag

The 1-bit flag can indicate whether the configured event is satisfied. For example, 0 (or 1) can indicate that the event is not satisfied (unsatisfied), and 1 (or 0) can indicate that the event is satisfied. The 1-bit flag indicates whether the RSRP-related condition separately configured in relation to the corresponding SSB index is satisfied. In the handover decision, it may be considered that whether the configured event is satisfied is more important than the exact measurement value.

While conventionally 13 bits were required for one measurement value, according to an embodiment of the disclosure, the new UCI format requires 7 bits for one measurement value, thereby reducing the uplink feedback overhead. According to the new UCI format, results for a plurality of measurement values (each measurement value corresponding to the 6-bit SSB index and the 1-bit flag) may be reported at one report timing, and the number of measurement values may be determined according to the number of target cells. That is, while only the most recent measurement value is reported in the conventional L1 MR, the new UCI format according to an embodiment of the disclosure may include all measurement values included in the report periodicity.

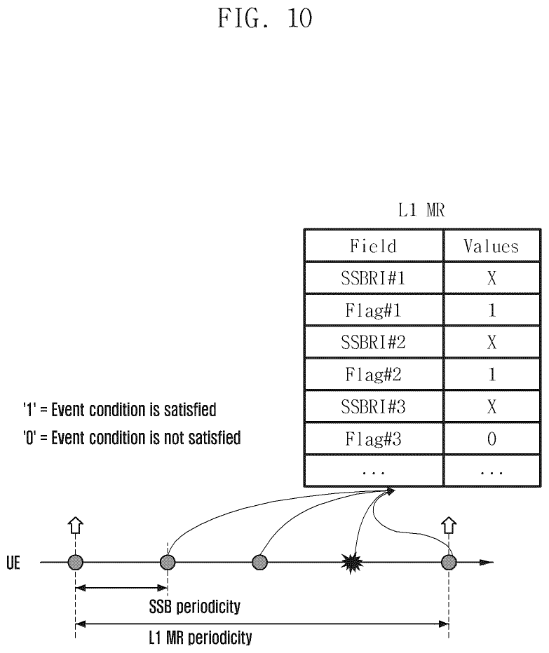

FIG. 10 illustrates an example of a new UCI format according to an embodiment of the disclosure.

According to an embodiment of the disclosure, the new UCI format includes one or more best SSB indices and one or more 1-bit flags. The 1-bit flag indicates whether an event related to a corresponding SSB (SSB resource indicator (SSBRI)) is satisfied. For example, the SSB periodicity may be 10 ms, the L1 MR periodicity may be 40 ms, and the RSRP related event corresponding to SSBRI #3 may not be satisfied. In this case, the new UCI format may include SSBRI #1, Flag #1 (configured as 1) corresponding to SSBRI #1, SSBRI #2, Flag #2 (configured as 1) corresponding to SSBRI #2, SSBRI #3, Flag #3 (configured as 0) corresponding to SSBRI #3, SSBRI #4, and Flag #1 (configured as 1) (not shown) corresponding to SSBRI #4.

In this example, according to the conventional L1 MR, a 13-bit UCI composed of 6 bits of SSB index and 7 bits of RSRP needs to be transmitted four times in total, so that a total of 52 bits are required. On the other hand, according to an embodiment of the disclosure, 7 bits composed of 6 bits of SSB index and 1-bit flag are transmitted for four samples, that is, a 28-bit UCI is transmitted once, thereby allowing a bit reduction gain of 46%.

According to an embodiment of the disclosure, the number of samples is calculated as follows:

$$\# of samples = Floor [ L 1 MR periodicity / SMTC ( SSB - based RRM Measurement Timing Configuration ) periodicity ]$$

According to an embodiment of the disclosure, the above condition (RSRP related condition corresponding to SSB) may be configured via higher layer signaling (RRC signaling). For example, a reportQuantity field may be added to LTM-CSI-ReportConfig (L1 MR related configuration for LTM). This may refer to Table 6.

TABLE 6

| reportQuantity CHOICE { | |
|---|---|
| ssb-Index-RSRP NULL, | |
| ssb-Index-Flag | ConditionConfig |

},

In the conventional L1 MR for LTM, ssb-Index-RSRP is basically used, and therefore, reportQuantity is not included in CSI-ReportConfig (L1 MR related configuration for LTM). According to an embodiment of the disclosure, ssb-Index-RSRP or ssb-Index-Flag may be indicated according to the reportQuantity configuration. If ssb-Index-RSRP is configured, this may indicate that the conventional LTM operation is configured. If ssb-Index-Flag is configured, this may indicate that the above-described operation according to an embodiment of the disclosure is configured.

If ssb-Index-Flag is configured, a condition for flag determination for the new UCI format according to an embodiment of the disclosure may be configured through higher layer signaling. For example, it may be conditioned through ConditionConfig. ConditionConfig may be defined by one or a combination of the following two methods.

(1) Method 1—New IE definition. For the new IE, it may refer to Table 7.

TABLE 7

```
ConditionConfig::= SEQUENCE {
  conditionId CHOICE {
    conditionA1 SEQUENCE {
      a1-Threshold MeasTriggerQuantity,
      hysteresis Hysteresis
    },
    conditionA2 SEQUENCE {
      a2-Threshold MeasTriggerQuantity,
      hysteresis Hysteresis
    },
    conditionA3 SEQUENCE {
      a3-Offset MeasTriggerQuantityOffset,
      hysteresis Hysteresis
    },
    conditionA4 SEQUENCE {
      a4-Threshold MeasTriggerQuantity,
      hysteresis Hysteresis
    },
    conditionA5 SEQUENCE {
      a5-Threshold1 MeasTriggerQuantity,
      a5-Threshold2 MeasTriggerQuantity,
      hysteresis Hysteresis
    },
  ...
},
```

(2) Method 2—Predefined eventConfig may be reused, and unused fields in ConditionConfig may be excluded. For the predefined eventConfig, it may refer to Table 8, and for example, reportOnLeave, timeToTrigger, useWhiteCellList, etc. may be excluded. In this case, the names of event fields except unused fields may be changed. For example, eventA1/2/3/4/5/6 may be changed to conditionA1/2/3/4/5/6.

TABLE 8

| | |
|---|---|
| EventTriggerConfig ::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
```

In Method 1, the conditions defined in Table 7 are as follows.
Condition A1 (Serving becomes better than threshold)
Condition A2 (Serving becomes worse than threshold)
Condition A3 (Neighbor becomes offset better than SpCell)
Condition A4 (Neighbor becomes better than threshold)
Condition A5 (SpCell becomes worse than threshold1 and neighbor becomes better than threshold2)

For example, in the case of Conditions A1/A2, whether the conditions are satisfied is reported for the serving cell, and in the case of Conditions A3/A4/A5, whether the conditions are satisfied is reported for the neighbor cell. Therefore, the total overhead that constitutes the UCI may be calculated differently depending on the configured condition:

$$In the case that conditionID = condition A 1 , condition A 2 ,$$

For the serving cell, a 1-bit flag may be fed back indicating whether the condition is satisfied for the best SSB index per measurement sample.

$$Total overhead = ( Best SSB index of serving cell ( 6 bits ) + Flag ( 1 bit ) ) \times Number of samples ( n ) = 7 n$$

In the case that conditionId=condition A3, condition A4, condition A5,
For the candidate target cells except the serving cell, a 1-bit flag may be fed back indicating whether the condition is satisfied for the best SSB index per measurement sample.

$$Total overhead = ( ( Best SSB index of candidate target cell ( 6 bits ) + Flag ( 1 bit ) ) \times Number of samples ( n ) ) \times Number of candidate target cells ( m ) = 7 nm$$

That is, according to an embodiment of the disclosure, the UCI may be composed depending on condition ID. That is, when the condition based on condition ID is for the serving cell, the UCI is composed as (Best SSB index of serving cell (6 bits)+Flag (1 bit)) x Number of samples (n)=7n, and when the condition based on condition ID is for the neighbor cell, the UCI may be composed as ((Best SSB index of candidate target cell (6 bits)+Flag (1 bit)) x Number of samples (n)) x Number of candidate target cells (m)=7 nm.

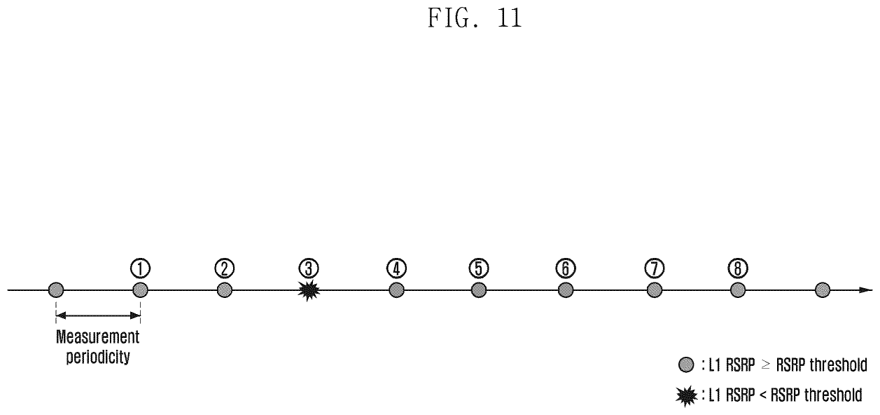

When the L1 MR according to an embodiment of the disclosure is used, the number of L1 MR transmissions and the amount of overhead are significantly reduced, while handover robustness can be maintained similar to conventional one. This will be described in detail with reference to FIG. 11.

FIG. 11 is a diagram illustrating a technical effect of a new UCI format according to an embodiment of the disclosure. Referring to FIG. 11, the case where the SSB transmission periodicity is configured as 10 ms is exemplified.

For example, in the case of L3 MR with TTT=80 ms, the third measurement value does not satisfy the condition, so the L3 MR is not triggered.

For example, in the case of L1 MR with periodicity=10 ms, the reported third measurement value does not satisfy the condition, so handover is not determined.

For example, in the case of L1 MR with periodicity=40 ms, only the fourth and eighth measurement values are reported in the L1 MR, and these measurement values satisfy the condition, so handover can be determined. However, although this method can reduce L1 MR overhead, the accuracy of handover decision is lowered. In other words, since the third measurement value does not satisfy the condition, handover should not actually be determined, but since the third measurement value is not reported, handover is determined, reducing the accuracy of handover decision.

On the other hand, in the case of the method according to an embodiment of the disclosure, for example, in the case of the L1 MR with a periodicity of 40 ms, whether the condition is unsatisfied for the third measurement value is reported, and thus, handover is not determined.

### 2. UCI Format for SR

Conventionally, the SR can be multiplexed with 2 bits of hybrid automatic repeat request acknowledgement (HARQ-ACK) (or two pieces of HARQ information) in physical uplink control channel (PUCCH) (or physical uplink shared channel (PUSCH)). Depending on whether the SR and two pieces of HARQ information are multiplexed in PUCCH, respective cases can be distinguished as shown in Table 9.

TABLE 9

| Case | HARQ | HARQ | SR |
|---|---|---|---|
| 0 | ACK | ACK | — |
| 1 | ACK | NACK | — |
| 2 | NACK | ACK | — |
| 3 | NACK | NACK | — |
| 4 | ACK | ACK | SR |
| 5 | ACK | NACK | SR |
| 6 | NACK | ACK | SR |
| 7 | NACK | NACK | SR |

For example, in cases 0 to 3, two pieces of HARQ information can be transmitted without multiplexing the SR. In cases 4 to 7, the SR can be transmitted multiplexed with two pieces of HARQ information.

According to an embodiment of the disclosure, eight cases of Table 9 can be changed and used as in Table 10 or Table 11 below.

Table 10 One HARQ Bit (without or with SR for Legacy and Event-Triggered UCI)

TABLE 10

| Case | HARQ | SR for legacy | SR for eUCI |
|---|---|---|---|
| 0 | ACK | — | — |
| 1 | NACK | — | — |
| 2 | ACK | SR | — |
| 3 | NACK | SR | — |
| 4 | ACK | — | SR |
| 5 | NACK | — | SR |
| 6 | ACK | SR | SR |
| 7 | NACK | SR | SR |

For example, according to an embodiment of the disclosure, the SR may be divided into legacy SR and SR for event-triggered UCI (eUCI). In cases 0 and 1, one HARQ information may be transmitted without multiplexing of the legacy SR and the SR for eUCI. In cases 2 and 3, the legacy SR may be transmitted multiplexed with one HARQ information. In cases 4 and 5, the SR for eUCI may be transmitted multiplexed with one HARQ information. In cases 6 and 7, the legacy SR and the SR for eUCI may be transmitted multiplexed with one HARQ information.

Table 11 One HARQ bit (without or with SR for legacy and event-triggered UCI)

TABLE 11

| | | SR for | SR for | SR for |
|---|---|---|---|---|
| Case | HARQ | legacy | eUCI 1 | eUCI 2 |
| 0 | ACK | — | — | — |
| 1 | NACK | — | — | — |
| 2 | ACK | SR | — | — |
| 3 | NACK | SR | — | — |
| 4 | ACK | — | SR | — |
| 5 | NACK | — | SR | — |
| 6 | ACK | — | — | SR |
| 7 | NACK | — | — | SR |

For example, according to an embodiment of the disclosure, the SR may be divided into legacy SR and SR for eUCI. In addition, the SR for eUCI may be divided into SR for eUCI 1 and SR for eUCI 2 depending on the type of eUCI. In cases 0 and 1, one HARQ information may be transmitted without multiplexing of the legacy SR, the SR for eUCI 1, and the SR for eUCI 2. In cases 2 and 3, the legacy SR may be transmitted multiplexed with one HARQ information. In cases 4 and 5, the SR for eUCI 1 may be transmitted multiplexed with one HARQ information. In cases 6 and 7, the SR for eUCI 2 may be transmitted multiplexed with one HARQ information.

In Tables 10 and 11 above, the legacy SR refers to a case where the SR is triggered by a legacy condition. That is, it may be a case where a UL grant is requested for data transmission in an RLC/PDCP buffer having a logical channel ID. The SR for eUCI refers to a case where it is triggered by a UL grant request for event-triggered UCI transmission. Since the format of UCI needs to be known for UCI receiving/demapping/decoding at the PHY layer of the base station, the SR for legacy and the SR for eUCI should be distinguished.

If the SR for 2 bits is utilized in the form according to an embodiment of the disclosure, it is possible to distinguish between a case where the SR is triggered by a legacy condition and a case where the SR is triggered for eUCI transmission as described above. Also, as in Table 11, when the eUCI is generated and the SR is triggered, at least two eUCI formats may be distinguished.

According to an embodiment of the disclosure, in order to distinguish the format of eUCI mapped to the SR, the following configurations may be added to RRC.

### (1) Add RRC IE for Interpretation of 2-Bit SR Format

schedulingRequestWithUCI IE (It can be included in “schedulingRequestResourceToAddModList” or “schedulingRequestToAddModList”)
   False: (Legacy operation) Two HARQ bits (without or with SR)
   True: (According to an embodiment of the disclosure) 1 HARQ bit (without or with SR for legacy and eUCI)
      (2) Add RRC IE Indicating SR and eUCI Type Mapping Method
eUCIType1, eUCIType2 IE (It can be included in “schedulingRequestWithUCI”)
   Each indicates reportConfigId of event-triggered L1 MR. reportConfigId for event-triggered L1 MR may be introduced.
   If the method according to Table 10 is used, only eUCIType1 is used. If the method according to Table 11 is used, both eUCIType1/2 are used.

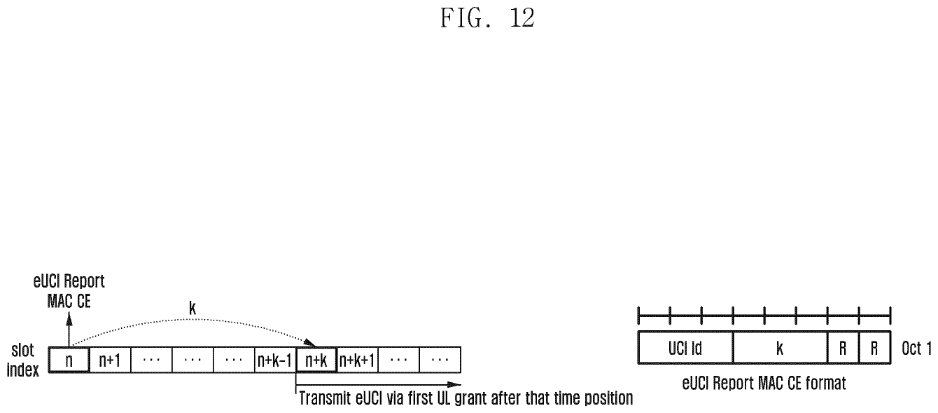

FIG. 12 is a diagram illustrating an example of a new MAC CE according to an embodiment of the disclosure.

According to an embodiment of the disclosure, a new MAC CE may be introduced to notify the transmission of eUCI. The new MAC CE may be a report of generation of an event-triggered UCI. The UE may notify a format of generated eUCI to the base station through the new MAC CE. The UE may notify, through the MAC CE, information that it will transmit eUCI through a UL grant allocated from the base station after a certain time from transmission of the MAC CE. The MAC CE may be composed as follows:
UCI ID (3 bits): Indicates the ID of the event-triggered UCI
k (3 bits): Indicates the minimum number of time slots between MAC CE transmission and eUCI transmission

The UE may transmit the UCI in the eUCI format indicated by the UCI ID through the first uplink grant after k slots from MAC CE transmission time slot n.
R: Reserved bit

The bits for UCI ID and k described above may be configured differently under the condition that the total bit sum does not exceed 8 bits, rather than 3 bits each as exemplified above. Meanwhile, a method of mapping which format of UCI is used for each UCI ID and a method of mapping the k value are as follows.
eUCI ID Mapping Method
   Add eUCIformatConfig IE. It may be configured as RRC IE and may be a list of eUCIformatConfig. Or, eUCIformatConfig itself may be a list of eUCI formats.
      eUCI ID=n in MAC CE indicates the nth configured value in the list, and one eUCI format may indicate reportConfigId of event-triggered L1 MR.
k Value Mapping Method
   Alt1. Without a separate IE, index k in MAC CE indicates the number of k slots.
   Alt2. Add eUCIConfigList IE
      Index k in MAC CE indicates the kth configured value in the list.

### 3. LTM Support Method for Legacy UE

Even for legacy UEs, for example, processing of a cell switch command through MAC CE, PRACH-based early synchronization, etc. may be supported through software upgrades, etc. However, depending on hardware capabilities, UE-based early synchronization, L1 MR, etc. may not be supported. Accordingly, an LTM support method for legacy UEs is required.

For example, for legacy UEs, PRACH-based early synchronization may be used instead of UE-based early synchronization.

For example, for legacy UEs, L3 MR may be used instead of L1 MR. Referring back to FIG. 6, the L3 MR may be used for candidate target cell selection (S605), cell switch trigger (S630, instead of L1 MR). However, the L3 MR is delivered to the CU located in the RRC layer, and in case of the LTM, handover decision is made in the DU located in the MAC layer, so the L3 MR should be able to be transferred from the CU to the DU.

According to an embodiment of the disclosure, an F1AP message is proposed to transfer the L3 MR from the CU to the DU (from the RRC layer to the MAC layer).

### DU_CU L3 MR Information Transfer

Transferred from CU to DU
Contains RRC L3 MR information

According to an embodiment of the disclosure, the L3 MR can be transferred from the CU to the DU through the F1AP message, thereby enabling the LTM to be supported for legacy UEs.

Hereinafter, at least some of the various embodiments of the disclosure will be described in more detail. Hereinafter, detailed description that overlaps with the above description will be omitted.

The LTM technique, which supports beam and cell-level mobility and significantly reduces handover interruption time through early synchronization, is expected to be defined as a baseline mobility technique for 5G-Advanced and 6G. However, as the handover trigger criterion in LTM changes from an event-based L3 measurement report (MR) to an instantaneous value-based L1 MR, the issues of handover failure or ping-pong (PP) effects may be intensified when commercializing LTM.

To address these challenges, the disclosure proposes a new handover decision mechanism that is more robust than legacy L3-based handover and can flexibly cope with situation like radio link failure (RLF). Additionally, to overcome the long-standing weakness in commercial system handover scenarios, where conservative link adaptation is applied due to the lack of initial channel state information (CSI) immediately after handover, the disclosure proposes an early CSI acquisition scheme based on the nature of the LTM procedure.

In the 5G-Advanced and 6G, supporting seamless mobility may be difficult due to the emergence of ‘killer services’ that demand simultaneous satisfaction of three traffic characteristics: high data rate, short packet delay budget (PDB), and short packet arrival rate. The reason is that major services managed by the baseline L3 handover (e.g., voice over Internet protocol (VOIP), over-the-top (OTT), and Internet traffic) cannot support all three characteristics.

Various mobility technologies introduced in Release 16 can provide mobility for these new services, but there are the following limitations. For example, conditional handover allows the UE to directly trigger the handover, reducing handover decision time, but it still has long handover interruption time (HIT) due to the RACH procedure. Handover using the make-before-break mechanism based on the dual active protocol stack (DAPS) can minimize the HIT, but it has limitations such as implementation complexity and lack of support for frequency range 2 (FR2).

The LTM, which can overcome the limitations of these conventional mobility technologies, has been newly introduced in Release 18. The LTM can minimize the HIT by skipping the RACH procedure through the early synchronization. Additionally, by performing the handover decision at the DU instead of the CU, it minimizes handover delay caused by the CU-DU wired section.

However, despite various technical advantages of the LTM, there are several problems, as follows.

1. Change in handover decision criteria: In the LTM, as the criterion for determining handover execution shifts to L1 MR filtered at the UE, handover failure or ping-pong problems can be intensified due to fluctuating channel characteristics. Accordingly, a new gNB-based L2 filter and handover decision mechanism are needed instead of simply applying the method used in legacy L3 HO.

2. Temporary low data rate immediately after handover: As a chronic problem that continues to 5G in practical systems, it is necessary to solve the problem of temporarily providing only a low data rate by allocating conservative modulation and coding scheme (MCS) level and number of layers due to the absence of initial channel state information (CSI) immediately after handover. As a result, in the case of extended reality (XR) traffic, the data burst may not be transmitted within PDB immediately after handover, and thus service disconnection may occur.

Among the emerging usage of the next generation of mobile communication systems, XR is one of the most prominent. The XR traffic has a distinct traffic characteristics from the perspectives of PDB, packet arrival rate, and data burst volume.
PDB (τ): XR applications require low latency for seamless user experience. If a data burst is not completely transmitted within the PDB, it will be discarded at the application layer. The typical requirement of PDB is 10 ms.
Packet Arrival Rate (λ): XR traffic has high and consistent frames per second (fps) rates.
Data Burst Volume (B): In the case of XR traffic with data rate of 30 Mbps (or 45 Mbps) per user, a very large data burst size occurs for each frame.

The calculation method for the required data rate of XR traffic varies depending on the relationship between the PDB and the packet arrival rate. If the PDB is longer than the packet arrival rate, the required data rate is calculated based on the data burst size per packet arrival rate. Conversely, if the PDB is shorter than the packet arrival rate, the required data rate is calculated based on the data size per PDB. This is because if the data burst within the PDB is not fully transmitted, the data burst is discarded at the packet data convergence protocol (PDCP) layer or application layer.

In the mobility scenario for XR traffic, delays caused by handover interruptions can significantly impact user experience and performance. Fortunately, the HIT can be reduced through early synchronization in the LTM procedure. However, immediately after the handover, the link adaptation is limited due to the absence of CSI. That is, even if the channel conditions are good, a temporary data rate degradation occurs due to the low MCS level and the small number of layers allocated, which may cause some data bursts to be discarded because they cannot be transmitted within the PDB. This problem can have a fatal impact on the XR service quality, so an early CSI acquisition scheme is required to solve it.

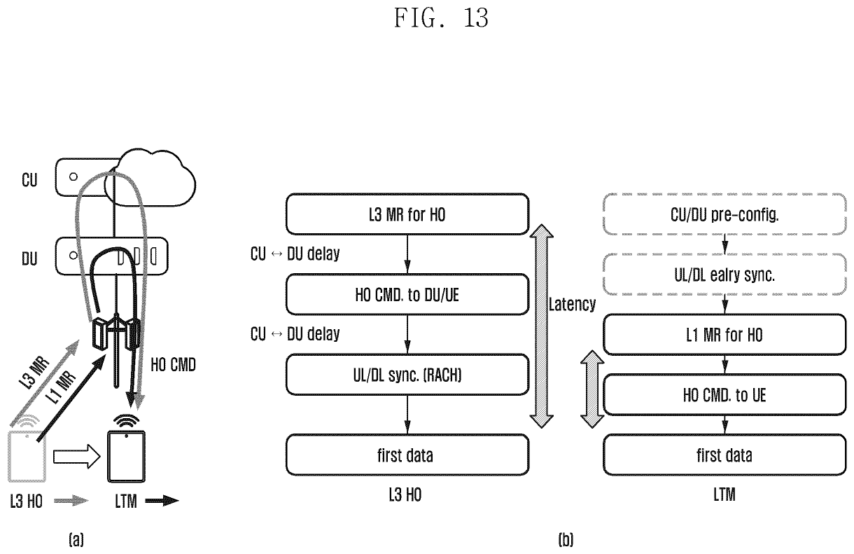

FIG. 13 is a diagram illustrating an LTM procedure according to an embodiment of the disclosure. Specifically, FIG. 13 shows comparison between L3 handover (HO) and LTM, where part (a) shows a handover decision flow and part (b) shows a handover latency.

Referring to part (a) of FIG. 13, the handover decision in the legacy L3 HO is made at the CU, but the handover (more precisely, the cell switch) decision in the LTM is made at the DU.

Referring to part (b) of FIG. 13, in the L3 HO, the first data is transmitted after transmission of L3 MR for handover, transmission of handover command to DU/UE, and UL/DL synchronization (RACH procedure), thereby causing latency, whereas in the LTM, the first data is transmitted after transmission of L1 MR and transmission of handover command (cell switch command) to UE, thereby relatively reducing latency. That is, compared to the legacy L3 HO, the LTM can significantly reduce the HIT through pre-processing of UE and early DL/UL synchronization.

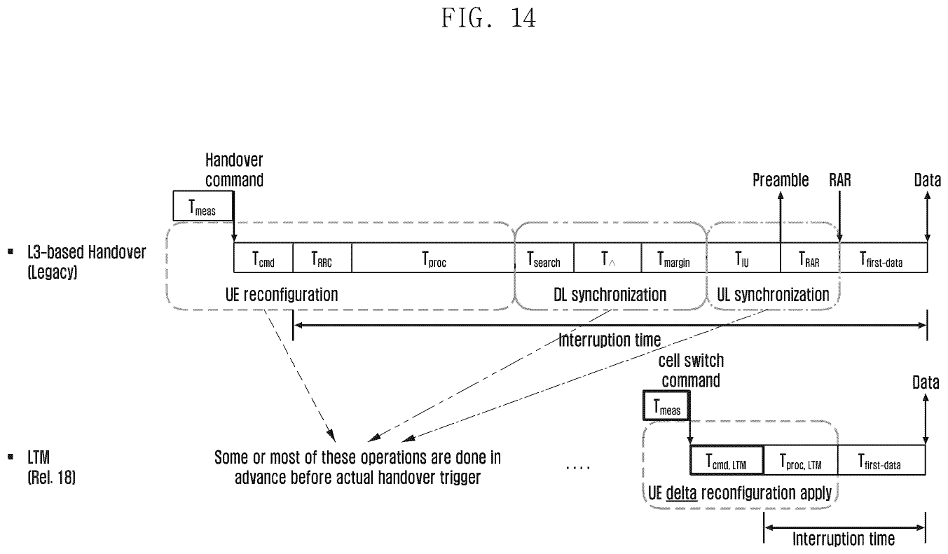

FIG. 14 is a diagram illustrating a comparison of HIT between an L3-based handover and an LTM according to an embodiment of the disclosure.

The HIT of L3-based handover, T_{L3}, is defined as the time from the last transmission time interval (TTI) containing the handover command on the old physical downlink shared channel (PDSCH) to the time when the UE performs the first PDSCH reception or PUSCH transmission on the indicated beam for the target cell. T_{L3} can be expressed as follows:

$${T}_{L 3} = {T}_{RRC} + {T}_{proc} + {T}_{sync} + {T}_{data}$$

T_{RRC} is the time for processing the RRC reconfiguration message for the handover command.

T_{proc} is the time for processing after the handover command. For example, it may include the time required for L2/L3 reconfiguration, RF/baseband retuning, security update, etc.

T_{sync} consists of T_{DL-sync} and T_{UL-sync}. T_{DL-sync} denotes the time for downlink (DL) synchronization and consists of T_{search}+T_{Δ}+T_{margin}. T_{search} is the time required to search for the target cell when the target cell is not already known when the handover command is received by the UE. T_{Δ} is the time for fine time tracking and acquiring full timing information of the target cell. T_{margin} is the time for SSB post-processing, and can be up to 2 ms. T_{UL-sync} denotes the time for uplink (UL) synchronization and consists of T_{IU}+T_{RAR}. T_{IU} is the interruption uncertainty in acquiring the first available PRACH occasion in a new cell. T_{RAR} is the time for random access response (RAR) delay.

T_{data} represents the time for the UE to perform the first PDSCH reception or PUSCH transmission on the indicated beam for the target cell after the RAR (or cell change command).

The HIT of LTM, T_{LTM}, is defined as the time from the time the UE receives the cell switch command message to the time the UE performs the first PDSCH reception or PUSCH transmission on the indicated beam for the target cell. When the operation of DL/UL early synchronization procedure is performed, T_{LTM} is given as follows:

$${T}_{LTM} = {T}_{proc , LTM} + {T}_{data}$$

In the LTM, the processing time T_{proc} can be reduced due to the pre-processing. Therefore, remaining processing time is represented by T_{proc,LTM}, which includes early ASN.1 decoding, validity/compliance check, processing for applying target cell parameters, and L1/L2 changes.

Table 12 shows a comparison of parameter values related to T_{L3} and T_{LTM} for mobility from FR1 to FR1.

TABLE 12

| Parameters | T_{L3} | T_{LTM} |
|---|---|---|
| T_{RRC} | up to 10 ms | n/a |

| | |
|---|---|
| T_{proc} | same FR: up to 20 ms |

| | | |
|---|---|---|
| T_{search} | i) 0 ms | 0 ms |
| | ii) Tᵣₛ ms | |
| | iii) 3 · Tᵣₛ ms | |
| T_{Δ} | Tᵣₛ ms | n/a |
| T_{margin} | up to 2 ms | n/a |
| T_{IU} | Typ. 15 ms | n/a |
| T_{RAR} | Typ. 4 ms | n/a |

The time required for target cell search, T_{search}, is divided into the following three cases:
i) when the target cell is already known,
ii) when the target cell is an unknown intra-frequency cell,
iii) when the target cell is an unknown inter-frequency cell.

Since cell search and timing information tracking/acquisition are performed based on SSB signal, Tsearch and TΔ depend on the SSB-based measurement timing configuration (SMTC) periodicity of the target cell, Trs, which is usually set to 20 ms.

In the legacy L3 handover, when entry conditions of certain events are satisfied during TTT, the UE reports the L3 MR to the base station, and the base station decides the handover based on this. In general, whether the entry condition of a certain event is satisfied or not is determined based on values obtained by applying the L3 filtering to L1 filtered measurements.

However, in the LTM, since L1 measurements are periodically reported to the base station regardless of event conditions, it is necessary for the base station to apply L2 filtering similar to the legacy L3 filtering at the UE.

If RSRP measurements are selected as the criteria for determining the handover trigger in the LTM, the L2 filtering with an infinite impulse response (IIR) filter can be considered to reduce the residual fluctuation in L1 filtered RSRP measurements P^{L1}[t] at UE's reporting timing (or instance) t and increase an accuracy. Then, L2 filtering is applied using Equation 1 below:

$${P}^{L 2} [ t ] = ( 1 - α ) \cdot {P}^{L 2} [ t - 1 ] + α \cdot {P}^{L 1} [ t ] \qquad Equation 1$$

Here, α=(0.5)^{k}^{_{L2}}^{/4} is the forgetting factor which controls the impact of the previous L2 filtered value P^{L2}[t−1] on the currently updated filtered value, and k_{L2} is the filter coefficient. For convenience in notation, the instance term t will be omitted.

The TTT mechanism, which is widely used for L3 MR trigger, is one of the most straight-forward solutions to mitigate the ping-pong problems. Therefore, a method similar to the TTT-based handover decision mechanism can be used as the default handover decision mechanism in the LTM.

A time parameter TTT_{L2} is newly defined so that a handover is triggered only when specific L2 filtered radio conditions persist for a certain period of time.

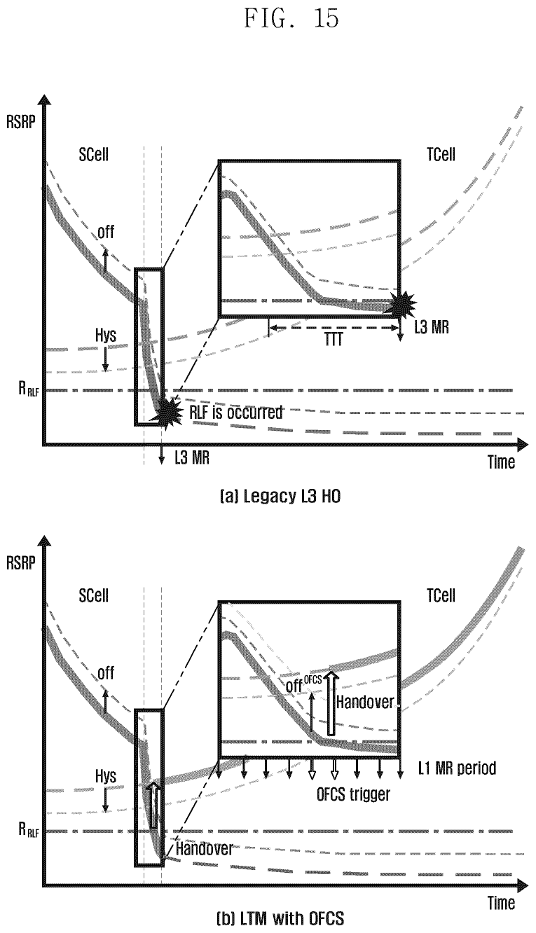

FIG. 15 is a diagram illustrating a handover behavior when a radio channel condition is rapidly deteriorated according to an embodiment of the disclosure.

Referring to part (a) of FIG. 15, the major weakness of TTT-based handover decision is that it is vulnerable to scenarios where a handover trigger is delayed and radio link failure may occur when the signal strength of the serving cell rapidly deteriorates. On the other hand, in the LTM, the base station can detect in real time situations where the received signal power of the serving cell changes rapidly through the periodic L1 MR. Accordingly, to cope with the radio link failure caused by the above reason, an additional time parameter TTT_{L1} is defined to trigger a handover only when specific L1 filtered radio conditions persist for a certain period of time.

To introduce handover decision conditions in the LTM, an intra-frequency handover scenario is assumed. In addition, for the sake of explanation convenience, cell-specific or object-specific offsets are not considered.

When TTT_{L2} is given, the triggering condition for handover execution is expressed as follows.

$$C 1 : {P}_{n}^{L 2} - Hys > {P}_{s}^{L 2} + Off ,$$

Here, Hys is the hysteresis parameter and Off is the offset parameter. The subscript notation s and n denote the serving cell and the neighbor cell, respectively.

The cancellation condition for handover execution is expressed as follows.

$$C 2 : {P}_{n}^{L 2} + Hys < {P}_{s}^{L 2} + Off .$$

Since such triggering/cancellation conditions are similar to conditions of the existing event A3 (Neighbor becomes offset better than serving), it can provide a handover success rate similar to that of legacy L3 HO. However, in situations where the radio channel condition deteriorates rapidly, the above method may also cause radio link failure due to the late handover trigger.

The disclosure proposes an opportunistic fast cell switch (OFCS) scheme that can proactively handle situations where radio link failure may occur. Referring to part (b) of FIG. 15, the OFCS scheme is based on periodic L1 MRs for handover decisions in the LTM. The OFCS can be used along with the above-described trigger/cancellation conditions for handover execution.

When TTT_{L1} is given, the triggering conditions of OFCS are C1, C3, and C4, which are expressed as follows, respectively.

$$C 3 : {P}_{n}^{L 2} - Hys > {P}_{s}^{L 1} + {Off}^{OFCS} ,$$

$$C 4 : {γ}^{th} > {γ}_{s}^{PUCCH} ,$$

Here, Off^{OFCS} is the offset parameter for OFCS, and

$${γ}_{s}^{PUCCH} and {γ}^{th}$$

denote the PUCCH SINR of the serving cell and PUCCH SINR threshold, respectively. C3 and C4 are conditions for detecting instantaneous DL channel state degradation and UL channel state degradation, respectively. The cancellation conditions of OFCS are as follows.

$$C 5 : {P}_{n}^{L 2} + Hys < {P}_{s}^{L 1} + {Off}^{OFCS} ,$$

$$C 6 : {γ}^{th} < {γ}_{s}^{PUCCH} .$$

If the conditions C1, C3, and C4 are met simultaneously for a relatively short period of TTT_{L1} compared to TTT_{L2}, then a handover execution is triggered by OFCS. The reason for adding condition C1 is to prevent OFCS trigger caused by temporary instantaneous channel degradation due to channel fluctuations.

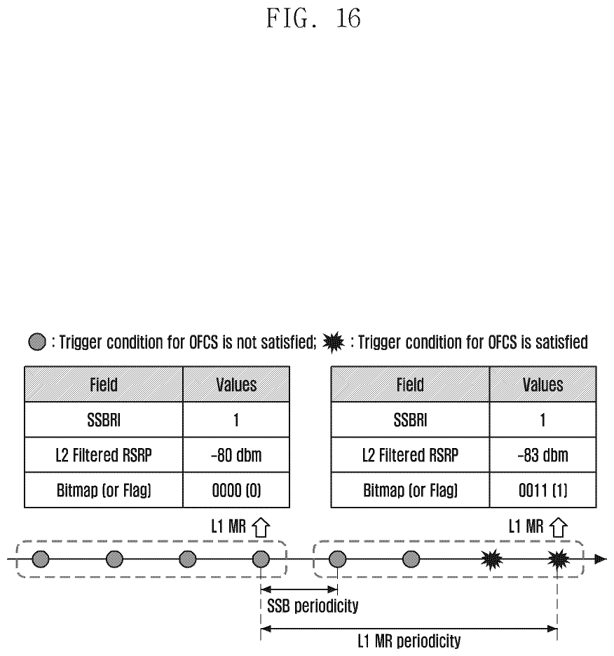

FIG. 16 is a diagram illustrating an example of a UCI format for L1 MR according to an embodiment of the disclosure.

As described above, there exists a trade-off relationship between the amount of UL feedback overhead for L1 MR and handover decision robustness. The L1 MR for LTM includes only the best SSB indices and RSRP values measured most recently, which requires a lot of UL feedback overhead to report all SSB measurements. On the contrary, if the periodicity of L1 MR is increased to reduce the UL feedback overhead, the base station receives only some SSB measurements, resulting in a decrease in handover decision robustness.

According to an embodiment of the disclosure, proposed is a UCI format for L1 MR that can minimize UL feedback overhead while maintaining handover decision robustness, along with the UE behavior for it. For convenience of explanation, it is assumed that the UE is capable of performing the above-described L2 filtering and can assess the triggering/cancellation conditions C3 and C5. It is also assumed that there is only one reference signal reported by L1 MR.

According to an embodiment of the disclosure, whether the trigger condition is satisfied or not for each SSB measurement can be reported by using only one bit to reduce UL feedback overhead. The UCI format according to an embodiment of the disclosure is composed of best SSB index, L2 filtered SSB RSRP, and bitmap.

The best SSB index represents the SSB with the strongest L2 filtered SSB RSRP during the L1 MR period. The length of bitmap corresponds to the number of measured SSB bursts between L1 MR periods. For example, as shown in FIG. 16, if there are 4 measured SSB bursts between L1 MR transmission periods, the length of each bitmap becomes 4. In the bitmap, each bit represents ‘1’ when condition C3 is triggered for a specific SSB measurement value, and ‘0’ when condition C5 is triggered. Lastly, the triggering condition satisfaction results based on the time order of measured SSB are represented from the most significant bit (MSB) to the least significant bit (LSB).

In the comparison between conventional L1 MR with the L1 MR according to an embodiment of the disclosure in the example of FIG. 16, the UL feedback overhead is reduced by 67%. In the conventional L1 MR case, 13 bits are needed for each SSB measurement, with 6 bits for the SSB index and 7 bits for RSRP, totaling 52 bits for 4 SSB measurements. However, for the L1 MR according to an embodiment of the disclosure, 17 bits are necessary for 4 SSB measurements, including 6 bits for the best SSB index based on L2 filtered value during 4 SSB measurements, 7 bits for L2 filtered SSB RSRP, and 4 bits for bitmap. If a flag indicating that an OFCS event has been triggered is used instead of a bitmap, the UL feedback overhead can be reduced by up to 73%. Although the bitmap is illustrated in FIG. 16, the UCI format according to an embodiment of the disclosure is not limited thereto. For example, the SSB RSRP 7 bits may be omitted and a 1-bit flag corresponding to each SSB may be concatenated to each SSBRI, as previously described with reference to FIG. 10.

Hereinafter, link adaptation enhancement immediately after handover according to an embodiment of the disclosure will be described.

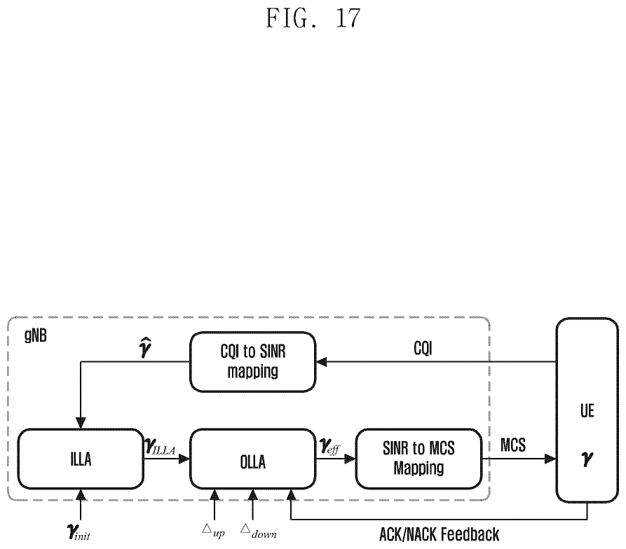

FIG. 17 is a diagram illustrating an example of link adaptation according to various embodiments of the disclosure.

The base station can optimize the link quality by selecting MCS based on channel quality indicator (CQI) and acknowledgement/negative ACK (ACK/NACK) feedback received from the UE. The UE can generate the CQI based on the measured channel state (γ, SINR) and transmit it to the base station. The base station can convert the CQI into an estimated SINR \hat{γ} according to CQI to SINR mapping. In the initial link level adaptation (ILLA), γ_{ILLA} can be generated based on a reference SINR γᵢₙₜ and \hat{γ}. In the outer loop link adaptation (OLLA), γ_{ILLA} is corrected based on the ACK/NACK feedback to generate an effective SINR γ_{eff}. For example, it may be lowered when NACK is received, and increased when ACK is received. The MCS may be selected in the SINR to MCS mapping according to γ_{eff}.

As described above, the DL link adaptation algorithm adjusts the effective SINR (γ_{eff}) which is the estimate of received SINR. Then, appropriate MCS level and number of layers are allocated based on it.

In general, the serving cell processes the reported CQI value to obtain an estimate of the measured SINR (\hat{γ}). However, the actual SINR of PDSCH used for data transmission is different from the SINR of CSI-RS due to the difference in applied beamforming weight or the difference in whether or not interference occurs. In addition, the accuracy of \hat{γ} may decrease due to differences in the mapping curves used by the UE and the link adaptation algorithm to determine the SINR threshold for each CQI. For this reason, the ILLA manages γ_{ILLA} updated through a moving average calculation or reflected only when specific conditions are satisfied.

Although the average SINR can be estimated through the ILLA, the OLLA is required to cope with both the outdated CSI and fading channel changed in unit of TTI. The OLLA adjusts the effective SINR γ_{eff} based on the ACK/NACK feedback of HARQ. It can be expressed as follows:

$${γ}_{eff} = {γ}_{ILLA} + {Δ}_{offset}$$

Here, Δ_{offset} is the offset value with respect to the HARQ feedback results. If the ACK is received, Δ_{offset} is increased as follows:

$${Δ}_{offset} ← {Δ}_{offset} + {Δ}_{up}$$

On the other hand, if the NACK is received, Δ_{offset} is decreased as follows:

$${Δ}_{offset} ← {Δ}_{offset} - {Δ}_{down}$$

The step size is configured to satisfy the target block error rate (BLER_{target}). The relationship between Δᵤₚ and Δ_{down} is as follows:

$${Δ}_{up} = {Δ}_{down} \times \frac{{BLER}_{target}}{1 - {BLER}_{target}} .$$

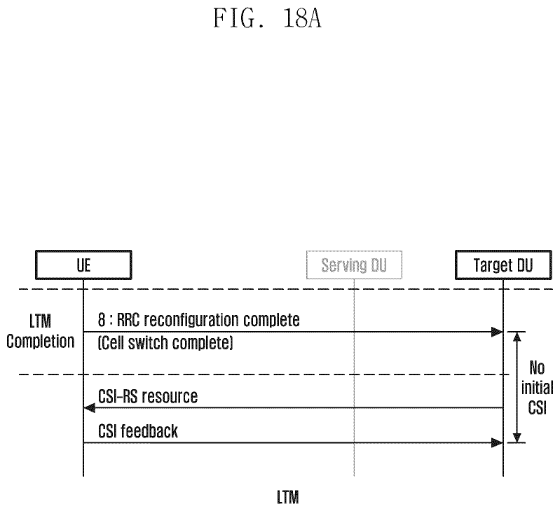

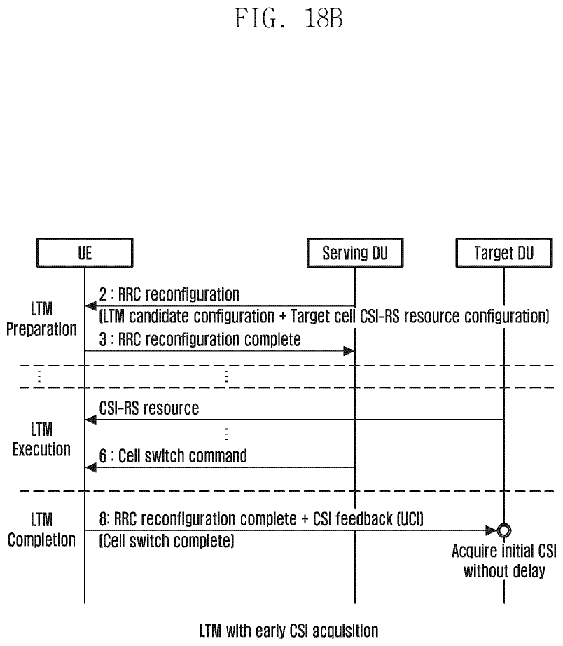

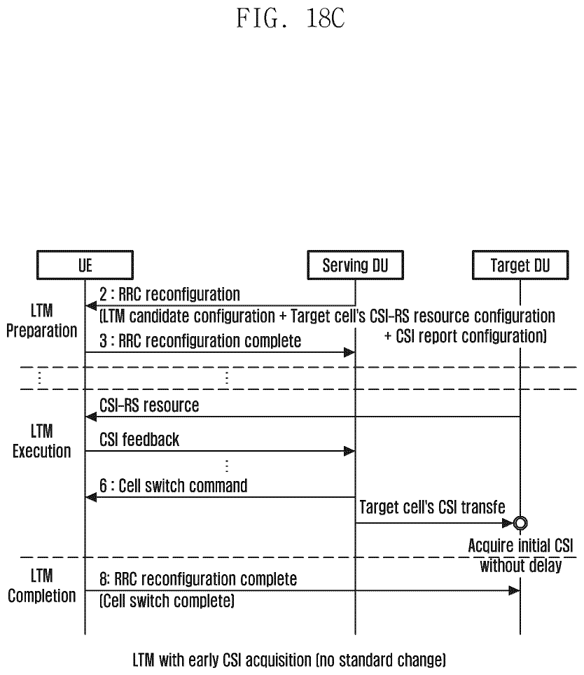

FIGS. 18A, 18B and 18C are diagrams illustrating an example of an early CSI acquisition operation according to an embodiment of the disclosure.

Since there is no initial CSI immediately after an initial access or handover, the value of γ_{ILLA} is initialized to the fixed value γᵢₙᵢₜ. Herein, the γᵢₙᵢₜ value is set low to provide robust link quality, which also leads to a low γ_{eff} value. This causes a situation in which a low MCS level is used because γ_{eff} is low even if the actual SINR is good immediately after handover. In addition, since there is no rank indicator (RI) during the time for absence of initial CSI, the number of layers to be allocated is also set low.

If the first CSI feedback arrives, the OLLA can update γ_{eff} to a suitable level for the actual SINR. Then, through the SINR-to-MCS mapping operation, appropriate MCS level can be allocated. Furthermore, through the first CSI feedback, target DU can obtain the RI and allocate an appropriate number of layers based on it.

In order to minimize the time for absence of initial CSI, it is necessary to minimize the difference between the transmission timing of cell switch complete message and the CSI feedback timing, which corresponds to the duration of no initial CSI in FIG. 18A. After the UE transmits RRC reconfiguration complete (cell switch complete), it can receive CSI-RS resources from the target DU and transmit CSI feedback. The time from the transmission of RRC reconfiguration completion to the transmission of CSI feedback corresponds to the duration of no initial CSI.

However, there are several issues in minimizing the difference between the transmission timing of cell switch complete message and the CSI feedback timing. First of all, it is difficult to change the CSI feedback offset immediately before handover trigger. This is because it has already been set through the LTM candidate configuration. On the other hand, if the cell switch complete message is transmitted according to the CSI feedback offset, too early/late handover may occur.

To solve this problem, the early CSI acquisition scheme is proposed according to an embodiment of the disclosure, in which the UE can acquire the CSI of the target cell before handover execution and immediately feed back the corresponding CSI to the target cell immediately after handover. It is assumed that the target cell operates the cell-specific CSI-RS resource, and the UE has the capability to calculate CSI based on the CSI-RS of the non-serving cell. Referring to FIG. 18B, the early CSI acquisition scheme according to an embodiment of the disclosure does not change the existing LTM procedure, but some configurations are added as follows.

First, the serving cell obtains configuration information about the cell-specific CSI-RS resources of the target cell through the LTM candidate cell preparation procedure. Thereafter, the serving cell configures the UE to receive the CSI-RS of the target cell through the RRC reconfiguration message. The UE calculates CQI and RI for the CSI-RS of the target cell, but corresponding CSI does not feed back to the serving cell because the serving cell does not configure periodic CSI report. Instead, an aperiodic CSI report is configured, which will be used to trigger CSI reporting to the target cell. Herein, each CSI report has unique CSI report configuration ID.

Second, the MAC CE used for the cell switch command message is utilized to trigger the CSI report of the target cell. The corresponding MAC CE contains target configuration ID, TA command, transmission configuration indication (TCI) state ID, preamble index, SSB index, PRACH mask index, etc. One alternative is to use reserved bits within the MAC CE to indicate the CSI report configuration ID of the aperiodic CSI report to be triggered. Another alternative is to map the CSI report configuration ID for the aperiodic L1 CSI report to the target configuration ID included in the existing MAC CE and to notify the corresponding relationship through the RRC reconfiguration message. Thereafter, an aperiodic L1 CSI report is triggered upon receiving the cell switch command message.

Finally, referring to FIG. 18C, the triggered CSI report is transmitted to the target cell together with the cell switch complete message of step 8. This is different from the conventional method in which the UE monitors only the CSI-RS of the serving cell and reports it to the serving cell. The CSI of the target cell and the cell switch complete message are generated by the physical layer and the RRC layer, respectively, and both are delivered to the target cell with the shortest delay time because they are transmitted through the first UL grant (i.e., the same PUSCH). To this end, the first UL grant size should be equal to or larger than the sum of the UCI size for CSI report and the data size of the RRC message for cell switch completion.

The LTM procedure is an optimized structure for the early CSI acquisition of the target cell because the source cell can know the expected target cell in advance, and there is a spare time until the handover is triggered. Due to the early acquired CSI, the value of γ_{ILLA} immediately after handover is updated by an appropriate value based on the reported CQI rather than a low value set for robust link quality. Furthermore, the number of allocated layers may also be determined as an appropriate value based on the RI value. In addition to the above advantages, the initial SINR can be increased by applying UE-specific beamforming weight based on the PMI feedback because the CSI report quantity generally include CQI, RI, precoding matrix indicator (PMI), and CSI-RS resource indicator (CRI).

Referring to FIG. 18C, it is another example of the early CSI acquisition scheme according to an embodiment of the disclosure. The additions compared to the procedure illustrated in FIG. 18B are as follows. First, the RRC reconfiguration message us used to configure a CSI report that feeds the CSI of the target cell back to the serving cell. Second, the serving cell transfers the received target cell's CSI to the target cell via a vendor-specific link between DUs (e.g., backhaul) immediately after sending the cell switch command message. While the scheme according to FIG. 18B requires modification of the conventional standard, the scheme according to FIG. 18C has the advantage of not requiring modification of the conventional standard.

Hereinafter, experimental examples (simulation results) according to an embodiment of the disclosure is described. This is for explaining the technical effects according to an embodiment of the disclosure, and the disclosure is not limited thereto. The simulation environment is as shown in Table 13.

TABLE 13

| Parameters | Values |
|---|---|
| Channel model | 3D-UMa channel model [3] |
| Bandwidth/SCS | 20 MHz/30 kHz (TTI = 0.5 ms) |
| Carrier frequency | 3.5 GHz |
| # of beams (SSBs) | 1 (common beam is assumed) |
| # of Tx/Rx ports | 32/4 (up to 4 layers) |
| Transmit power | 41 dBm |
| MCS/CQI table | 256 QAM-based table |
| Δ_{down}/BLER_{target} | 1 dB/10% |
| Overhead ratio | 0.2985 |
| TTT_{L1}/TTT_{L2} | 60 ms/160 ms (=TTT for L3 HO) |
| Hys/Off/Off^{OFCS} | 0 dB/1 dB/3 dB |
| UE speed | 60 km/h (for subsection 6.1) |
| | 3 km/h (for subsection 6.2) |
| RS periodicity | SSB periodicity = 20 ms |
| | CSI report periodicity = 40 ms |
| fps/λ | 60 fps/16.67 ms |
| Data burst size | 63,000 bytes |
| PDB | 10 ms |
| Required data rate | about 30 Mbps (per sec) |
| | about 50 Mbps (to satisfy PDB) |

In order to evaluate the mobility performance of the proposed solution according to an embodiment of the disclosure, a scenario is considered in which a UE moves for several tens of seconds in a 19-cell environment with 3 sectors per cell. Here, LTM-FT with L2 filtering and TTT (LTM-FT) according to an embodiment of the disclosure, and LTM-FT with opportunistic fast cell switching (OFCS) (LTM-FT-OFCS) according to an embodiment of the disclosure are compared against the legacy L3 HO and the existing LTM in terms of major handover key performance indicators (KPIs). This is shown in Table 14.

TABLE 14

| Mobility Scheme | HOF | RLF | PP | Reliability |
|---|---|---|---|---|
| L3 HO | 1.508 | 1.206 | 0.905 | 98.71% |
| LTM | 2.714 | 1.508 | 45.829 | 97.62% |
| LTM-FT | 1.206 | 0.905 | 1.206 | 99.69% |
| LTM-FT-OFCS | 0.905 | 0.603 | 3.618 | 99.59% |

Handover failure (HOF) is defined as an event that is triggered for handover but actually results in a failed handover. Among various causes of HOF, radio link failure (RLF) that is declared when the T310 timer expires was observed. Also, as a KPI expected to be deteriorated in LTM, ping-pong (PP) was observed. The PP refers to an instance where the handover to the target cell is successful but the UE performs another handover to the previous serving cell within 1 second. The number of HOF, RLF, and PP are normalized per UE per minute and they are shown together with the reliability in Table 13. Here, the reliability refers to a percentage of the time during which the UE is able to transmit/receive data, excluding the time spent on handover.

Table 14 shows the results of the performance evaluation in mobility scenarios. In terms of HOF, LTM shows the worst performance. This is because the handover decision in LTM relies solely on one L1 MR, where the L1 RSRP value reported by L1 MR can be fluctuated due to only L1 filtering being applied. On the other hand, LTM-FT according to an embodiment of the disclosure reduces HOF by about 55% and 20% compared to LTM and L3 HO, respectively. These benefits comes from making handover decisions based on L2 filtered L1 RSRP values and TTT behavior, combined with the procedural advantages over L3 HO. LTM-FT-OFCS according to an embodiment of the disclosure, which can proactively respond to situations where RLF may occur, shows the best performance by reducing HOF by about 40% compared to L3 HO.

Looking at the results of RLF, it is observed that the trend of the results is similar to the trend of the HOF results. This is because RLF is the primary cause of HOF, and the main cause of HOF occurring can change depending on parameters such as TTT, T310, offsets, and other parameters. LTM generates the most PPs, which is a phenomenon resulting from making handover decisions based on a single L1 MR. Through the application of L2 filtering and TTT at the base station, this issue can be improved to a performance similar to L3 HO, as confirmed by the PP results of LTM-FT and LTM-FT-OFCS according to an embodiment of the disclosure. However, since LTM-FT-OFCS according to an embodiment of the disclosure uses a short TTTL1 to minimize the number of RLFs, it is observed that the number of PPs is relatively higher compared to LTM-FT according to an embodiment of the disclosure.

As described above, the HIT is substantially reduced in LTM over L3 HO. Thus, LTM-FT and LTM-FT-OFCS according to an embodiment of the disclosure outperform L3 HO in terms of reliability. However, in the case of the existing LTM, since HO decision depends on only one L1 MR that might be highly fluctuating, the HOF is nearly twice as high as that of L3 HO, and the PP is also much higher than PP of L3 HO. Thus, the reliability performance of the existing LTM is confirmed to be inferior to that of L3 HO.

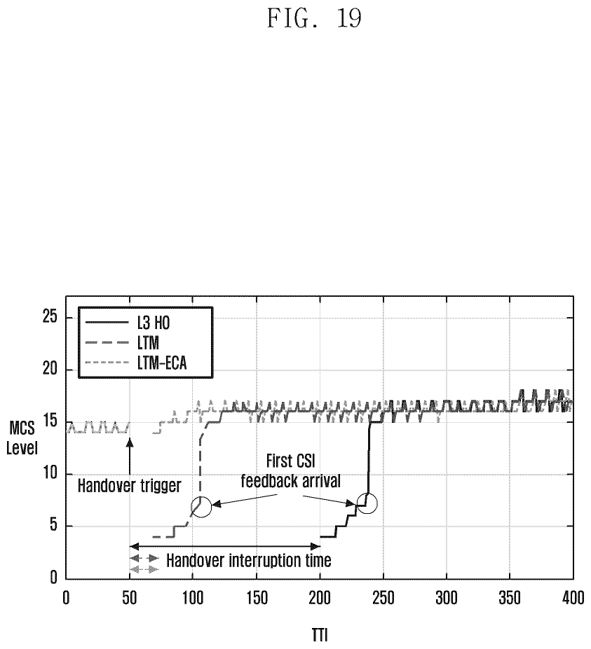

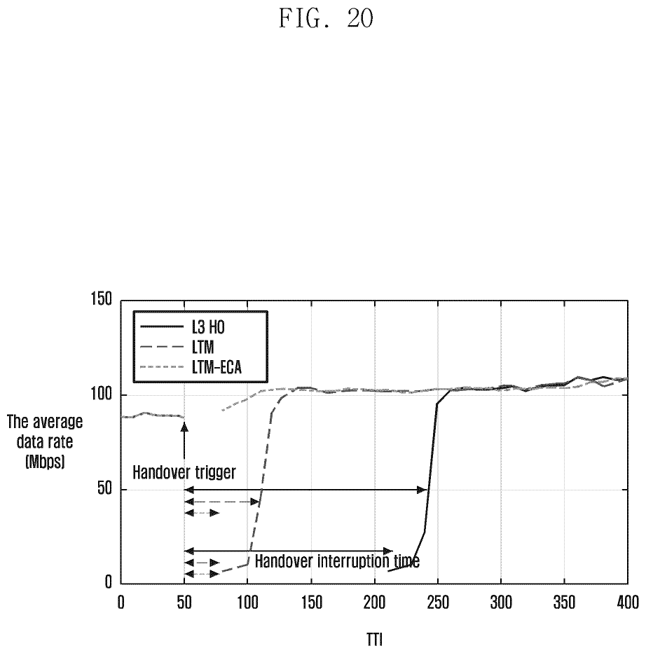

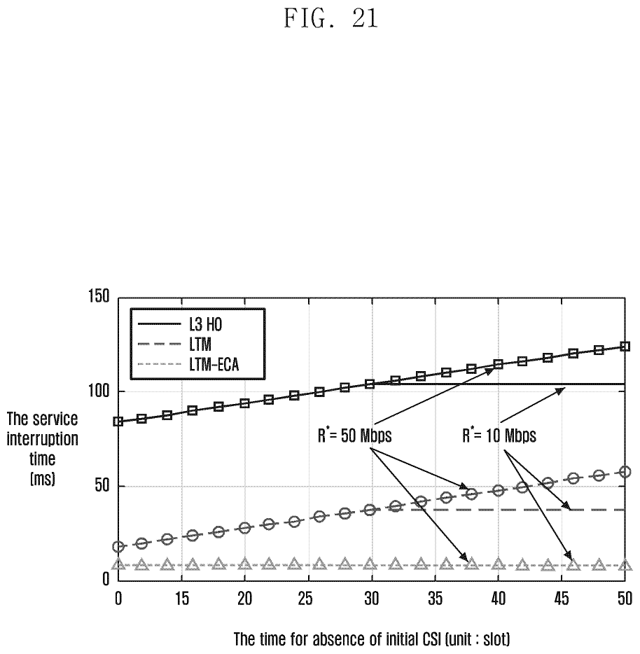

FIGS. 19, 20, and 21 illustrate examples of a simulation result related to early CSI acquisition according to various embodiments of the disclosure. Specifically, FIG. 19 is related to MCS level, FIG. 20 is related to average data rate, and FIG. 21 is related to average service interruption time.

Considered here is a single UE handover scenario between adjacent cells in the dense urban deployment environment. For convenience, it is assumed that measured CSI immediately before and after the handover have CQI 9 and RI 4. The real-time performance changes are observed in units of TTI in terms of the MCS level and the average data rate. For the performance comparison of both the HIT and service interruption time (SIT), it is assumed that the UE moves on the same path and triggers handover at the same timing for all mobility schemes.

FIGS. 19 and 20 respectively show the change in MCS level and average data rate when the UE moves from the source cell to the target cell. First of all, all mobility schemes have the same link adaptation aspect before the handover is triggered since the UE moves on the same path. After the handover is triggered, the HIT of the L3 HO is about 74 ms, but LTM has the reduced HIT through early synchronization operation and is about 8 ms. Herein, the HIT value is applied based on the values in Table 11 where Tdata is assumed to be 3 ms.

After the HIT is over, in the L3 HO and the LTM, the OLLA operates based on the γinit value during the time for absence of initial CSI, and the MCS level that requires a lower SINR than the actual SINR value is assigned. On the other hand, in the LTM-early CSI acquisition (LTM-ECA) according to an embodiment of the disclosure, because the pre-acquired CSI is delivered together with the cell switch complete message, an appropriate MCS level is selected based on the reported CQI rather than the γinit value immediately after handover.

In L3 HO and LTM schemes, only OLLA operates are performed until the CSI feedback arrives, and a single layer is allocated. Therefore, the average data rate increases gradually only by the increment of MCS level. After the CSI feedback arrives, the data rate increases significantly by allocating four layers based on the reported RI. Due to the HIT and time for absence of initial CSI, the SIT not satisfying QoS requirements of XR traffic during handover is estimated to be about 80 ms and 30 ms for L3 HO and LTM, respectively. Meanwhile, it is confirmed that LTM-ECA according to an embodiment of the disclosure outperforms the L3 HO and LTM since LTM-ECA has the SIT of about 10 ms. This is because the LTM-ECA according to an embodiment of the disclosure provides the CSI to the target cell immediately after handover without additional delay.

If the γinit value is set large, the SIT caused by the time for absence of initial CSI in the L3 HO and LTM may be minimized. But there is a risk of happening a large amount of decoding failure when the handover is triggered while the actual SINR is low. Therefore, it is necessary to set the optimal γinit value, but it is difficult to set the optimal γinit value because the SINR values at which the handover is triggered are different even within the same cluster. On the other hand, the LTM-ECA according to an embodiment of the disclosure does not require optimization of the γinit value for each cluster and shows that the time for absence of initial CSI is minimized.

FIG. 21 shows the expected SIT according to the time for absence of initial CSI. When the required data rate is 10 Mbps, if the time for absence of initial CSI is greater than 30 ms, the SIT does not increase anymore because the required data rate is satisfied due to the OLLA operation. Meanwhile, when the required data rate is 50 Mbps, the SIT is determined by the CSI feedback timing because the required data rate may be satisfied only when the number of allocated layers is increased. On the other hand, since LTM-ECA according to an embodiment of the disclosure provides the CSI immediately after handover, it always has a constant SIT regardless of the time for absence of initial CSI.

According to an embodiment of the disclosure, techniques for the LTM, which is expected to be the baseline mobility technology for 5G-Advanced and 6G, are proposed. First, a handover decision mechanism is proposed to mitigate handover failure and ping-pong problems that may be exacerbated by the use of instantaneous value-based L1 measurements in the LTM. Additionally, by proposing an early CSI acquisition scheme that leverages the characteristic of LTM in pre-recognizing the target cell, a method is proposed to solve the link adaptation problem caused by the absence of initial CSI. According to an embodiment of the disclosure, more robust mobility can be ensured compared to the legacy L3 HO, and the traffic requirements of upcoming killer services can also be satisfied.

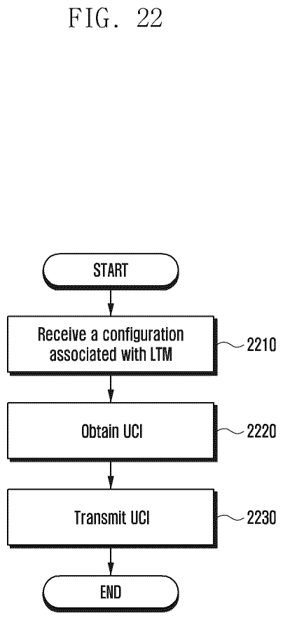

FIG. 22 is a diagram illustrating an example of an operation of a UE according to an embodiment of the disclosure.

The flowchart of FIG. 22 illustrates a method that may be implemented according to the principles of the disclosure, and various changes may be made to the method illustrated in the flowchart. For example, although a series of steps are illustrated, such steps may overlap, occur in parallel, occur in different orders, or occur multiple times. Alternatively, some steps may be skipped or replaced with other steps.

Referring to FIG. 22, in operation 2210, the UE may receive a configuration associated with layer 1/layer 2 triggered mobility (LTM) through higher layer signaling.

In operation 2220, the UE may obtain/generate uplink control information (UCI) for a layer 1 measurement report (L1 MR) related to the LTM.

In operation 2230, the UE may transmit the UCI.

According to an embodiment of the disclosure, the UCI may include information fields for N samples.

According to an embodiment of the disclosure, the information field for one sample may include 6-bit information indicating a synchronization signal block (SSB) index and 1-bit information corresponding to the SSB index and indicating whether an event condition configured for the L1 MR is satisfied.

For more specific details of the operation of the UE according to an embodiment of the disclosure, reference may be made to the above description of various embodiments of the disclosure.

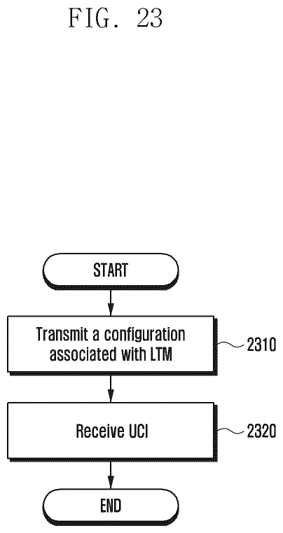

FIG. 23 is a diagram illustrating an example of an operation of a base station according to an embodiment of the disclosure.

The flowchart of FIG. 23 illustrates a method that may be implemented according to the principles of the disclosure, and various changes may be made to the method illustrated in the flowchart. For example, although a series of steps are illustrated, such steps may overlap, occur in parallel, occur in different orders, or occur multiple times. Alternatively, some steps may be skipped or replaced with other steps.

Referring to FIG. 23, in operation 2310, the base station may transmit a configuration associated with layer 1/layer 2 triggered mobility (LTM) through higher layer signaling.

In operation 2320, the base station may receive uplink control information (UCI) for a layer 1 measurement report (L1 MR) related to the LTM.

According to an embodiment of the disclosure, the UCI may include information fields for N samples.

According to an embodiment of the disclosure, the information field for one sample may include 6-bit information indicating a synchronization signal block (SSB) index and 1-bit information corresponding to the SSB index and indicating whether an event condition configured for the L1 MR is satisfied.

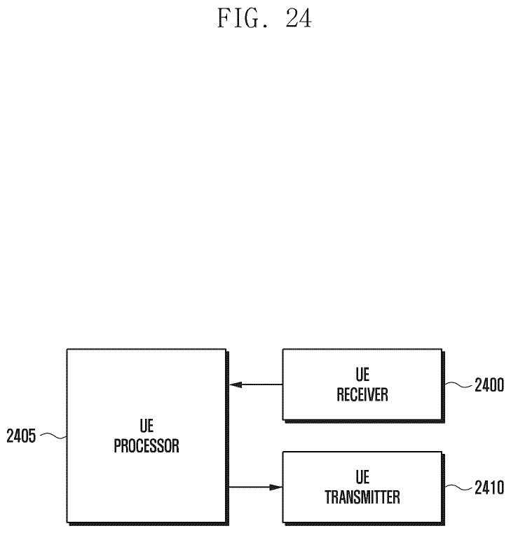

FIG. 24 is a diagram illustrating an example of a structure of a UE according to an embodiment of the disclosure.

Referring to FIG. 24, the UE may include a transceiver, which refers to a UE receiver 2300 and a UE transmitter 2410, a memory (not shown), and a UE processor 2405 (or a UE controller, a processor). Based on the above-described operation method of the UE, the transceiver 2400 and 2410, the memory, and the UE processor 2405 can operate. However, the components of the UE are not limited to those mentioned above. For example, the UE may include more or fewer components than the above-mentioned components. In addition, the transceiver, the memory, and the processor may be implemented in the form of a single chip.

The transceiver is capable of transmitting/receiving signals to/from a base station. Such signals may include control information and data. To this end, the transceiver may be composed of a radio frequency (RF) transmitter that up-converts and amplifies the frequency of an outgoing signal, and an RF receiver that low-noise amplifies an incoming signal and down-converts its frequency. However, this is merely one example of the transceiver, and the components of the transceiver are not limited to the RF transmitter and the RF receiver. In addition, the transceiver can receive a signal through a radio channel and output it to the processor, or transmit a signal outputted from the processor through a radio channel.

The memory can store programs and data required for the operation of the UE. In addition, the memory can store control information and/or data included in signals transmitted/received by the UE. The memory may be implemented with a storage medium such as ROM, RAM, hard disk, CD-ROM, and DVD, or a combination thereof. A plurality of memories may be used.

The processor can control a series of processes so that the UE can operate according to the above-described embodiments of the disclosure. There may be a plurality of processors, and the processor can perform a component control operation of the UE by executing a program stored in the memory.

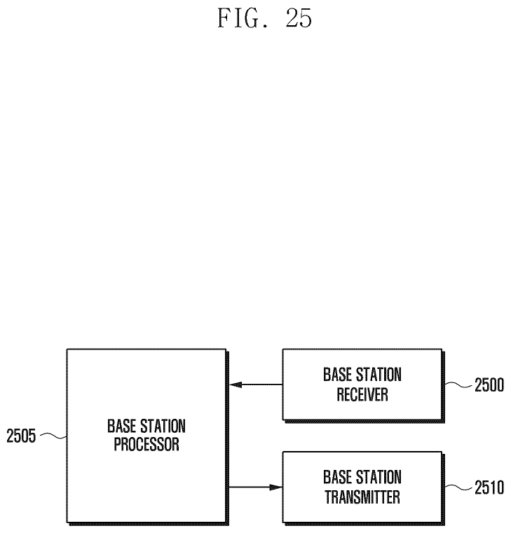

FIG. 25 is a diagram illustrating an example of a structure of a base station according to an embodiment of the disclosure.

Referring to FIG. 25, the base station may include a transceiver, which refers to a base station receiver 2500 and a base station transmitter 2410, a memory (not shown), and a base station processor 2505 (or a base station controller, or a processor). Based on the above-described operation method of the base station, the transceiver 2500 and 2510, the memory, and the base station processor 2505 can operate. However, the components of the base station are not limited to those mentioned above. For example, the base station may include more or fewer components than the above-mentioned components. In addition, the transceiver, the memory, and the processor may be implemented in the form of a single chip.

The transceiver is capable of transmitting/receiving signals to/from a UE. Such signals may include control information and data. To this end, the transceiver may be composed of an RF transmitter that up-converts and amplifies the frequency of an outgoing signal, and an RF receiver that low-noise amplifies an incoming signal and down-converts its frequency. However, this is merely one example of the transceiver, and the components of the transceiver are not limited to the RF transmitter and the RF receiver. In addition, the transceiver can receive a signal through a radio channel and output it to the processor, or transmit a signal outputted from the processor through a radio channel.

The memory can store programs and data required for the operation of the base station. In addition, the memory can store control information and/or data included in signals transmitted/received by the base station. The memory may be implemented with a storage medium such as ROM, RAM, hard disk, CD-ROM, and DVD, or a combination thereof. A plurality of memories may be used.

The processor can control a series of processes so that the base station can operate according to the above-described embodiments of the disclosure. There may be a plurality of processors, and the processor can perform a component control operation of the base station by executing a program stored in the memory.

The methods set forth in the appended claims or according to embodiments described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within an electronic device. The at least one program may include instructions that cause the electronic device to perform the methods set forth in the appended claims or according to embodiments described herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access an apparatus, which performs embodiments of the disclosure, via an external port. Further, a separate storage device on the communication network may access such an apparatus.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Meanwhile, the embodiments of the disclosure described or illustrated herein are merely provided as specific examples to easily explain the technical content of the disclosure and help understand the disclosure, and are not intended to limit the scope of the disclosure. That is, it is apparent to a person skilled in the art that other modified examples based on the subject matter of the disclosure are possible. In addition, as needed, the above-described embodiments can be combined totally or at least in part. For example, a part of one embodiment of the disclosure and a part of another embodiment may be combined to operate the base station and the UE.

Meanwhile, in the drawings illustrating the method according to the disclosure, the order of description does not necessarily correspond to the order of execution, and the order of precedence may be changed or executed in parallel.

Further, in the drawings illustrating the method according to the disclosure, some elements, components, operations, steps, or processes may be omitted within a scope that does not harm the subject matter of the disclosure.

In addition, the method according to the disclosure may be executed by a combination of some or all of the contents included in respective embodiments within a scope that does not harm the subject matter of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
receiving a configuration associated with a layer 1/layer 2 triggered mobility (LTM) through higher layer signaling;
obtaining uplink control information (UCI) for a layer 1 measurement report (L1 MR) related to the LTM; and
transmitting the UCI,
wherein the UCI includes information fields for N samples, and
wherein an information field for a sample includes 6-bit information indicating a synchronization signal block (SSB) index and 1-bit information corresponding to the SSB index and indicating whether an event condition configured for the L1 MR is satisfied.

2. The method of claim 1,
wherein N is defined by Floor {(periodicity configured for the L1 MR)/(SSB measurement timing configuration (SMTC) periodicity)},
wherein, in case that the event condition is for a serving cell, a number of bits of the UCI is 7N, and
wherein, in case that the event condition is for a neighbor cell, the number of bits of the UCI is 7NM where M is a number of neighbor cells.

3. The method of claim 2,
wherein the neighbor cell is a candidate target cell for the LTM, and
wherein, whether the event condition is for the serving cell or the neighbor cell is identified based on a condition identifier included in a condition configuration included in the configuration associated with the LTM.

4. The method of claim 1,
wherein the configuration associated with the LTM includes LTM-CSI-ReportConfig, and
wherein the LTM-CSI-ReportConfig includes a configuration indicating that the 6-bit information and the 1-bit information are included in the UCI.

5. The method of claim 1, further comprising:
transmitting a medium access control (MAC) control element (CE) indicating transmission of a scheduling request (SR) for the UCI in slot n;
transmitting the SR based on a first uplink grant received after slot n+k;
receiving an uplink grant in response to the SR; and
transmitting the UCI based on the uplink grant,
wherein the MAC CE includes information related to k and information related to an identifier of the UCI.

6. A terminal in a communication system, comprising:
a transceiver; and
a processor coupled to the transceiver and configured to:
receive a configuration associated with a layer 1/layer 2 triggered mobility (LTM) through higher layer signaling,
obtain uplink control information (UCI) for a layer 1 measurement report (L1 MR) related to the LTM, and
transmit the UCI,
wherein the UCI includes information fields for N samples, and
wherein an information field for a sample includes 6-bit information indicating a synchronization signal block (SSB) index and 1-bit information corresponding to the SSB index and indicating whether an event condition configured for the L1 MR is satisfied.

7. The terminal of claim 6,
wherein N is defined by Floor {(periodicity configured for the L1 MR)/(SSB measurement timing configuration (SMTC) periodicity)},
wherein, in case that the event condition is for a serving cell, a number of bits of the UCI is 7N, and
wherein, in case that the event condition is for a neighbor cell, the number of bits of the UCI is 7NM where M is a number of neighbor cells.

8. The terminal of claim 7,
wherein the neighbor cell is a candidate target cell for the LTM, and
wherein, whether the event condition is for the serving cell or the neighbor cell is identified based on a condition identifier included in a condition configuration included in the configuration associated with the LTM.

9. The terminal of claim 6,
wherein the configuration associated with the LTM includes LTM-CSI-ReportConfig, and
wherein the LTM-CSI-ReportConfig includes a configuration indicating that the 6-bit information and the 1-bit information are included in the UCI.

10. The terminal of claim 6,
wherein the processor is further configured to:
transmit a medium access control (MAC) control element (CE) indicating transmission of a scheduling request (SR) for the UCI in slot n,
transmit the SR based on a first uplink grant received after slot n+k,
receive an uplink grant in response to the SR, and
transmit the UCI based on the uplink grant, and
wherein the MAC CE includes information related to k and information related to an identifier of the UCI.

11. A method performed by a base station in a communication system, the method comprising:
transmitting a configuration associated with a layer 1/layer 2 triggered mobility (LTM) through higher layer signaling; and
receiving uplink control information (UCI) for a layer 1 measurement report (L1 MR) related to the LTM,
wherein the UCI includes information fields for N samples, and
wherein an information field for a sample includes 6-bit information indicating a synchronization signal block (SSB) index and 1-bit information corresponding to the SSB index and indicating whether an event condition configured for the L1 MR is satisfied.

12. The method of claim 11,
wherein N is defined by Floor {(periodicity configured for the L1 MR)/(SSB measurement timing configuration (SMTC) periodicity)},
wherein, in case that the event condition is for a serving cell, a number of bits of the UCI is 7N, and
wherein, in case that the event condition is for a neighbor cell, the number of bits of the UCI is 7NM where M is a number of neighbor cells.

13. The method of claim 12,
wherein the neighbor cell is a candidate target cell for the LTM, and
wherein, whether the event condition is for the serving cell or the neighbor cell is identified based on a condition identifier included in a condition configuration included in the configuration associated with the LTM.

14. The method of claim 11,
wherein the configuration associated with the LTM includes LTM-CSI-ReportConfig, and
wherein the LTM-CSI-ReportConfig includes a configuration indicating that the 6-bit information and the 1-bit information are included in the UCI.

15. The method of claim 11, further comprising:
receiving a medium access control (MAC) control element (CE) indicating transmission of a scheduling request (SR) for the UCI in slot n;
receiving the SR related to a first uplink grant transmitted after slot n+k;
transmitting an uplink grant in response to the SR; and
receiving the UCI related to the uplink grant,
wherein the MAC CE includes information related to k and information related to an identifier of the UCI.

16. A base station in a communication system, comprising:
a transceiver; and
a processor coupled to the transceiver and configured to:
transmit a configuration associated with a layer 1/layer 2 triggered mobility (LTM) through higher layer signaling, and
receive uplink control information (UCI) for a layer 1 measurement report (L1 MR) related to the LTM,
wherein the UCI includes information fields for N samples, and
wherein an information field for each sample includes 6-bit information indicating a synchronization signal block (SSB) index and 1-bit information corresponding to the SSB index and indicating whether an event condition configured for the L1 MR is satisfied.

17. The base station of claim 16,
wherein N is defined by Floor {(periodicity configured for the L1 MR)/(SSB measurement timing configuration (SMTC) periodicity)},
wherein, in case that the event condition is for a serving cell, a number of bits of the UCI is 7N,
wherein, in case that the event condition is for a neighbor cell, the number of bits of the UCI is 7NM where M is a number of neighbor cells 18.

18. The base station of claim 17,
wherein the neighbor cell is a candidate target cell for the LTM, and
whether the event condition is for the serving cell or the neighbor cell is identified based on a condition identifier included in a condition configuration included in the configuration associated with the LTM.

19. The base station of claim 16,
wherein the configuration associated with the LTM includes LTM-CSI-ReportConfig, and
wherein the LTM-CSI-ReportConfig includes a configuration indicating that the 6-bit information and the 1-bit information are included in the UCI.

20. The base station of claim 16,
wherein the processor is further configured to:
receive a medium access control (MAC) control element (CE) indicating transmission of a scheduling request (SR) for the UCI in slot n,
receive the SR related to a first uplink grant transmitted after slot n+k, transmit an uplink grant in response to the SR, and
receive the UCI related to the uplink grant, and
wherein the MAC CE includes information related to k and information related to an identifier of the UCI.
